(19) United States
(12) Patent Application Publication
(10) Pub. No.: US 2024/0155682 A1
(43) Pub. Date: May 9, 2024

(54) RTS-CTS PROCEDURE FOR EXTENDED RANGE PACKET TRANSMISSION

(71) Applicant: NXP USA, Inc., Austin, TX (US)

(72) Inventors: Priyanka Bansal, Lakheri (IN); Hari Ram Balakrishnan, Chennai (IN); Rui Cao, Sunnyvale, CA (US); Liwen Chu, San Ramon, CA (US); Sudhir Srinivasa, Los Gatos, CA (US)

(21) Appl. No.: 18/388,173

(22) Filed: Nov. 8, 2023

(30) Foreign Application Priority Data
Nov. 8, 2022 (IN) 202221063532

(51) Int. Cl. H04W 74/08

(52) U.S. Cl. CPC H04W 74/0816; H04W 84/12

(57) ABSTRACT

Embodiments of a method and apparatus for wireless communications are disclosed. In an embodiment, a wireless device includes a controller configured to generate an extended range request-to-send (ER-RTS) packet and a wireless transceiver configured to transmit the ER-RTS packet to a second wireless device to reserve a transmission channel.

### CROSS-REFERENCE TO RELATED APPLICATIONS

This application claims priority to Indian Provisional Patent Application Serial Number 202221063532, filed on Nov. 8, 2022, the contents of which are incorporated by reference herein.

### BACKGROUND

A secure transmission of an extended range (ER) packet from a source to a destination requires channel reservation. Typically, transmission based on a request-to-send (RTS) and a clear-to-send (CTS) scheme cannot reserve a transmission channel for an extended range, resulting in frame collisions during the transmission. Further, non-ER devices generally do not operate in ER range. Therefore, the non-ER devices may detect the transmission channel to be free even during an ongoing ER transmission, thus resulting in frame collisions and loss of data. Therefore, there is a need for extended range (ER) technology that can effectively reserve the transmission channel.

### SUMMARY

Embodiments of a method and apparatus for wireless communications are disclosed. In an embodiment, a wireless device includes a controller configured to generate an extended range request-to-send (ER-RTS) packet and a wireless transceiver configured to transmit the ER-RTS packet to a second wireless device to reserve a transmission channel.

In an embodiment, the transmission channel includes a wireless transmission channel between the wireless device and the second wireless device.

In an embodiment, the wireless transceiver is further configured to transmit data through the transmission channel after receiving an extended range clear-to-send (ER-CTS) packet from the second wireless device.

In an embodiment, two CTS packets are transmitted by the wireless device and the second wireless device before the ER-CTS packet is received by the wireless transceiver from the second wireless device.

In an embodiment, two CTS packets are simultaneously transmitted by the wireless device and the second wireless device before the ER-CTS packet is received by the wireless transceiver from the second wireless device. In an embodiment, an RTS packet is transmitted by the wireless

device to the second wireless device and a CTS packet is transmitted by the second wireless device to the wireless device before the ER-CTS packet is received by the wireless transceiver from the second wireless device.

In an embodiment, the wireless transceiver is further configured to transmit data through the transmission channel after two CTS packets are transmitted by the wireless device and the second wireless device.

In an embodiment, the wireless transceiver is further configured to transmit data through the transmission channel after two CTS packets are simultaneously transmitted by the wireless device and the second wireless device.

In an embodiment, the wireless transceiver is further configured to receive an ER-CTS packet from the second wireless device before two CTS packets are transmitted by the wireless device and the second wireless device.

In an embodiment, the wireless transceiver is further configured to transmit data through the transmission channel after receiving a CTS packet from the second wireless device.

In an embodiment, the wireless transceiver is further configured to receive an ER-CTS packet from the second wireless device before the CTS packet is received by the wireless transceiver from the second wireless device.

In an embodiment, the wireless device is compatible with an Institute of Electrical and Electronics Engineers (IEEE) 802.11 protocol.

In an embodiment, an RTS packet is transmitted by the wireless device to the second wireless device and a CTS packet is transmitted by the second wireless device to the wireless device.

In an embodiment, an extended range (ER) source compatible with an Institute of Electrical and Electronics Engineers (IEEE) 802.11 protocol includes a controller configured to generate an extended range request-to-send (ER-RTS) packet or an RTS packet and a wireless transceiver configured to transmit the ER-RTS packet or the RTS packet to an ER destination to reserve a wireless transmission channel between the ER source and the ER destination and to transmit data through the wireless transmission channel after receiving an extended range clear-to-send (ER-CTS) packet from the ER destination.

In an embodiment, two CTS packets are transmitted by the ER source and the ER destination before the ER-CTS packet is received by the wireless transceiver from the ER destination.

In an embodiment, two CTS packets are simultaneously transmitted by the ER source and the ER destination before the ER-CTS packet is received by the wireless transceiver from the ER destination.

In an embodiment, an RTS packet is transmitted by the ER source to the ER destination and a CTS packet is transmitted by the ER destination to the ER source before the ER-CTS packet is received by the wireless transceiver from the ER destination.

In an embodiment, the wireless transceiver is further configured to receive the ER-CTS packet from the ER destination before two CTS packets are transmitted by the ER source and the ER destination.

In an embodiment, the wireless transceiver is further configured to receive the ER-CTS packet from the ER destination before a CTS packet is received by the wireless transceiver from the ER destination.

In an embodiment, a method for wireless communications involves at a first wireless device, generating an ER-RTS packet and from the first wireless device, transmitting the ER-RTS packet to a second wireless device to reserve a transmission channel.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 illustrates a first channel reservation scheme in accordance with an embodiment of the present disclosure.

FIG. 2 illustrates a first table corresponding to step-wise summarization of the first channel reservation scheme in accordance with an embodiment of the present disclosure.

FIG. 3 illustrates a second channel reservation scheme in accordance with an embodiment of the present disclosure.

FIG. 4 illustrates a second table corresponding to step-wise summarization of the second channel reservation scheme in accordance with an embodiment of the present disclosure.

FIG. 5 illustrates a third channel reservation scheme in accordance with an embodiment of the present disclosure.

FIG. 6 illustrates a third table corresponding to step-wise summarization of the third channel reservation scheme in accordance with an embodiment of the present disclosure.

FIG. 7 illustrates a fourth channel reservation scheme in accordance with an embodiment of the present disclosure.

FIG. 8 illustrates a fourth table corresponding to step-wise summarization of the fourth channel reservation scheme in accordance with an embodiment of the present disclosure.

FIG. 9 illustrates a first mechanism that combines a first extension method and the first channel reservation scheme in accordance with an embodiment of the present disclosure.

FIG. 10 illustrates a fifth table corresponding to step-wise summarization of the first mechanism in accordance with an embodiment of the present disclosure.

FIG. 11 illustrates a second mechanism that combines the first extension method and the second channel reservation scheme in accordance with an embodiment of the present disclosure.

FIG. 12 illustrates a sixth table corresponding to step-wise summarization of the second mechanism in accordance with an embodiment of the present disclosure.

FIG. 13 illustrates a third mechanism that combines the first extension method and the third channel reservation scheme in accordance with an embodiment of the present disclosure.

FIG. 14 illustrates a seventh table corresponding to step-wise summarization of the third mechanism in accordance with an embodiment of the present disclosure.

FIG. 15 illustrates a fourth mechanism that combines the first extension method and the fourth channel reservation scheme in accordance with an embodiment of the present disclosure.

FIG. 16 illustrates an eighth table corresponding to step-wise summarization of the fourth mechanism in accordance with an embodiment of the present disclosure.

FIG. 17 illustrates a fifth mechanism that combines a second extension method and the first channel reservation scheme in accordance with an embodiment of the present disclosure.

FIG. 18 illustrates a ninth table corresponding to step-wise summarization of the fifth mechanism in accordance with an embodiment of the present disclosure.

FIG. 19 illustrates a sixth mechanism that combines the second extension method and the second channel reservation scheme in accordance with an embodiment of the present disclosure.

FIG. 20 illustrates a tenth table corresponding to step-wise summarization of the sixth mechanism in accordance with an embodiment of the present disclosure.

FIG. 21 illustrates a seventh mechanism that combines the second extension method and the third channel reservation scheme in accordance with an embodiment of the present disclosure.

FIG. 22 illustrates an eleventh table corresponding to step-wise summarization of the seventh mechanism in accordance with an embodiment of the present disclosure.

FIG. 23 illustrates an eighth mechanism that combines the second extension method and the fourth channel reservation scheme in accordance with an embodiment of the present disclosure.

FIG. 24 illustrates a twelfth table corresponding to step-wise summarization of the eighth mechanism in accordance with an embodiment of the present disclosure.

FIG. 25 illustrates a fifth channel reservation scheme in accordance with an embodiment of the present disclosure.

FIG. 26 illustrates a sixth channel reservation scheme in accordance with an embodiment of the present disclosure.

FIG. 27 illustrates a seventh channel reservation scheme in accordance with an embodiment of the present disclosure.

FIG. 28 depicts an ER transmission between an ER source and an ER destination in accordance with an embodiment of the invention.

FIG. 29 depicts a non-ER transmission between an ER source and an ER destination in accordance with an embodiment of the invention.

FIG. 30 depicts a non-ER transmission between an ER source and a non-ER destination in accordance with an embodiment of the invention.

FIG. 31 depicts a non-ER transmission between a non-ER source and an ER destination in accordance with an embodiment of the invention.

FIG. 32 depicts ER transmissions between an ER source and multiple ER destinations in accordance with an embodiment of the invention.

FIG. 33 depicts a wireless device in accordance with an embodiment of the invention.

FIG. 34 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In embodiments of a wireless communications system, a wireless device, e.g., an access point (AP) of a wireless local area network (WLAN) may transmit data to at least one associated station (STA) or vice versa. The AP may be configured to operate with associated STAs according to a communication protocol. For example, the communication protocol may be an Institute of Electrical and Electronics Engineer (IEEE) 802.11 communication protocol.

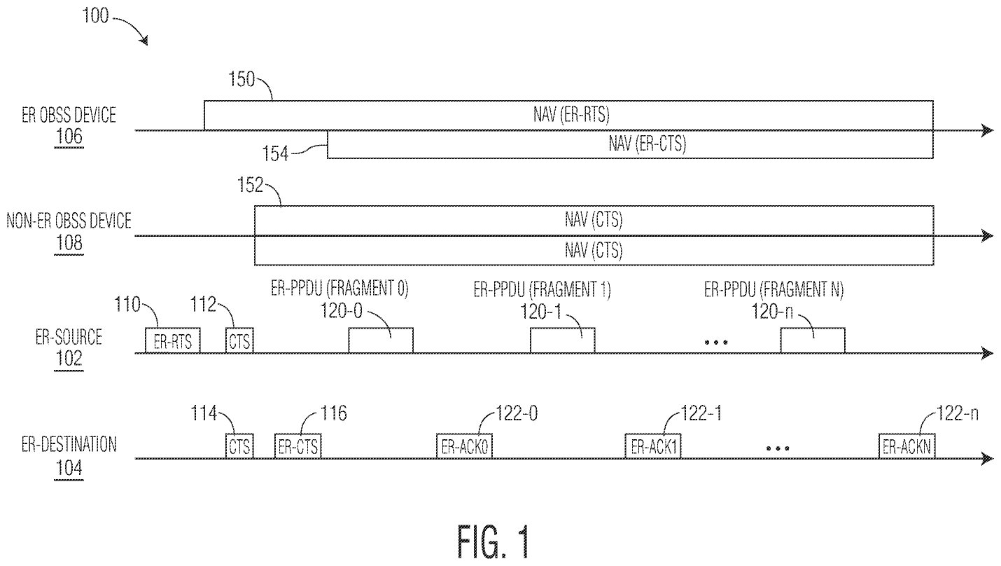

FIG. 1 illustrates a first channel reservation scheme 100 in accordance with an embodiment of the present disclosure. An extended range (ER) source 102 may be required to communicate with an ER destination 104. To enable the communication between the ER source and the ER destination, a transmission channel therebetween may be reserved. When the transmission channel is reserved for the ER source 102 and the ER destination 104, other devices may perceive the transmission channel to be unavailable for use. In some embodiments, the transmission channel is a wireless transmission channel between the ER source 102 and the ER destination 104. For example, the transmission channel is the wireless transmission medium between the ER source and the ER destination.

In the first channel reservation scheme 100, the ER source 102 may transmit an extended-range request-to-send (ER-RTS) packet 110 to the ER destination 104. The ER-RTS packet may contain a source address, a destination address, and a transaction duration. The transaction duration may indicate the time required for the completion of all transactions between the ER source and the ER destination. Further, one or more ER-other basic service set (OBSS) devices 106 may be configured to detect the ER-RTS packet transmitted by the ER source and update a network allocation vector (NAV) (ER-RTS) 150 thereof to indicate busy. The ER source may be further configured to transmit a clear-to-send (CTS) packet 112 to itself (e.g., a CTS-to-self packet). Additionally, the ER destination may be configured to transmit a CTS packet 114 to the ER source. Based on the CTS packet 114 transmitted by the ER destination, one or more non-ER OB SS devices 108 may be configured to update the status of their NAV (CTS) 152 to indicate busy. The ER-CTS packet 116 is then transmitted by the ER destination to the ER source. The CTS packet 112 transmitted by the ER source after the ER-RTS packet may include the address of the ER source and the transaction duration may be based on the ER-RTS packet duration. Further, the CTS packet 114 transmitted by the ER destination after receiving the ER-RTS packet may include the address of the ER source and the content thereof may be identical to that of the CTS packet from the ER source. The ER-CTS packet 116 transmitted by the ER destination may contain the ER-source address mentioned in the ER-RTS packet and the transaction duration may be such that it covers the reservation as per the ER-RTS duration. One or more ER-other basic service set (OBSS) devices 106 may be configured to detect the ER-CTS packet transmitted by the ER destination and update the network allocation vector (NAV) (ER-CTS) 154 thereof to indicate busy.

On receiving the ER-CTS packet 116 from the ER destination 104, the ER source 102 may determine that the transmission channel is reserved and may transmit an ER-physical layer protocol data unit (PPDU) packet to the ER destination in ‘n+1’ fragments 120-0, . . . , 120-n, where n is a positive integer. Based on the reception of each of the n+1-fragments of the ER-PPDU packet, the ER destination may be configured to transmit ‘n+1’ ER-acknowledgment (ACK) 122-0, . . . , 122-n (also referred to as ER-Ack0, ER-AckN) for the n+1-fragments of the ER-PPDU packet. In other words, based on receiving an ER-PPDU fragment 1, an ER-ACK1 may be transmitted by the ER destination.

In an embodiment, the ER source 102 may not receive the ER-CTS packet 116. In such a scenario, the ER source may be configured to wait for a time duration (e.g., short inter-frame spacing (SIFS)*2+CTS+slot time) and then transmit an extended-range-contention-free (ER-CF) end packet followed by the CF end packet to the ER destination 104. In another embodiment, the ER destination may not receive the ER-PPDU packets for a pre-defined time duration or may receive the ER-CF-end packet from the ER source. In such a scenario, the ER destination may transmit the ER-CF-end packet followed by the CF-end packet to the ER source. The ER-CF-end packet and the CF-end packet ordering may be interchanged.

Frame collisions may result from the conventional RTS/CTS mechanism's inability to reserve the channel for longer range. For example, non-ER devices which cannot operate in the ER range may detect the channel as free even if ER transmission is ongoing, which could result in collisions. By reserving the channel for extended range using the first channel reservation scheme 100 to reserve the channel for extended range, frame collisions caused by hidden nodes can be avoided.

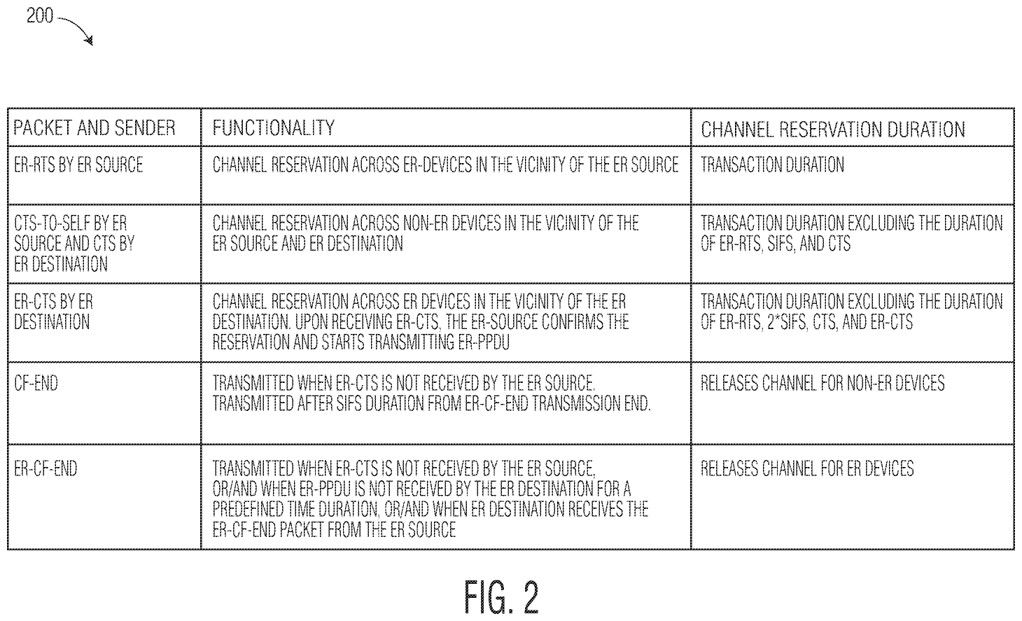

FIG. 2 illustrates a first table 200 corresponding to step-wise summarization of the first channel reservation scheme 100 depicted in FIG. 1 in accordance with an embodiment of the present disclosure. The first table 200 illustrates the packet and the sender, the functionality of each packet, and the channel reservation duration based on each packet for the first channel reservation scheme 100 depicted in FIG. 1. Each row of the table corresponds to one step.

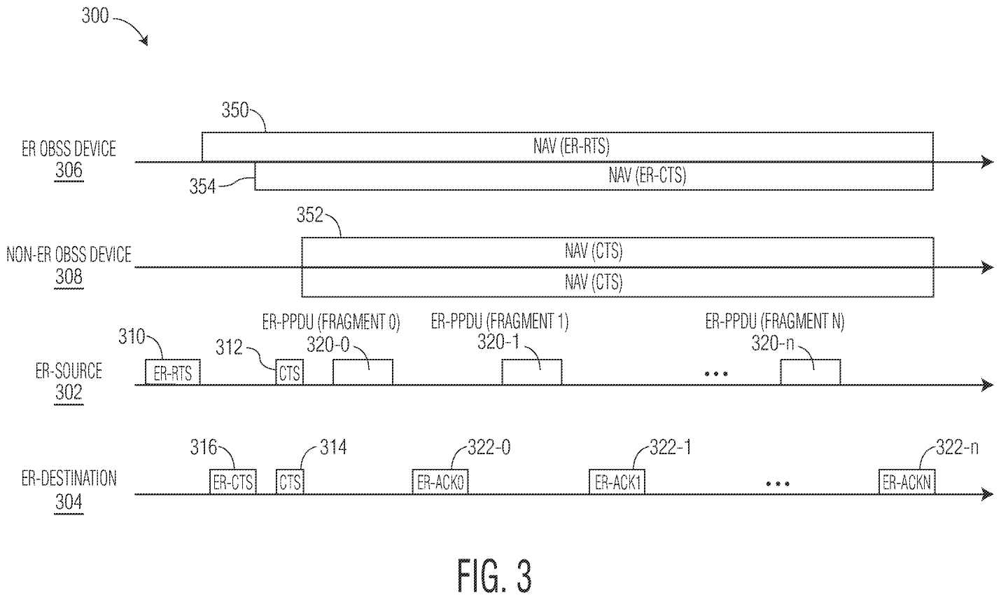

FIG. 3 illustrates a second channel reservation scheme 300 in accordance with an embodiment of the present disclosure. An extended range (ER) source 302 may be required to communicate with an ER destination 304. To enable the communication between the ER source and the ER destination, a transmission channel therebetween may be reserved. When the transmission channel is reserved for the ER source 302 and the ER destination 304, other devices may perceive the transmission channel to be unavailable for use. In some embodiments, the transmission channel is a wireless transmission channel between the ER source and the ER destination. For example, the transmission channel is the wireless transmission medium between the ER source and the ER destination. In the second channel reservation scheme 300, the ER source 302 may transmit an ER-RTS packet 310 to the ER destination 304. The ER-RTS packet may contain the source address, the destination address, and the transaction duration. Further, one or more ER-OBSS devices 306 in the vicinity of the ER source may be configured to detect the ER-RTS packet and update the NAV (ER-RTS) 350 of each of the ER-OBSS devices to indicate busy. Further, the ER destination may be configured to transmit the ER-CTS packet 316 to the ER source. The ER-CTS packet may include the source address and the transaction duration excluding the ER-RTS packet duration, the SIFS, and the ER-CTS duration. The ER-OB SS devices in the vicinity of the ER destination may be configured to detect the ET-CTS packet and update the status of their NAV (ER-CTS) 354 to indicate busy. Further, the ER source may be configured to transmit a CTS-to-self packet 312 and the ER destination may be configured to transmit a CTS packet 314 to the ER source simultaneously. Based on the CTS packets, one or more non-ER-based devices 308 in the vicinity of the ER source and ER destination may update the status of their NAV 352 to indicate busy. The CTS packet 314 transmitted by the ER destination may include the source address of the ER source and the transaction duration based on the ER-RTS packet excluding the SIFS duration and the duration of the ER-CTS packet. Further, the CTS-to-self packet 312 may include the source address and the duration may indicate the transaction duration excluding the ER-RTS duration, ER-CTS duration, two times the SIFS duration, and the duration of the CTS-to-self packet. Additionally, the CTS packet 314 transmitted by the ER destination may include the source address, and the transaction duration will remain the same as in the CTS-to-self packet. On receiving the ER-CTS packet from the ER destination, the ER source may determine that the channel is reserved and may transmit the ER-PPDU packet to the ER destination in ‘n+1’ fragments 320-0, . . . , 320-n, where n is a positive integer as described in FIG. 3. Based on the reception of each of the n+1-fragments of the ER-PPDU packet, the ER destination may be configured to transmit ‘n+1’ ER-acknowledgment (ACK) 322-0, . . . , 322-n (also referred to as ER-Ack0, ER-AckN) for the n+1-fragments of the ER-PPDU packet. In other words, based on receiving an ER-PPDU fragment 1, an ER-ACK1 may be transmitted by the ER destination.

In an embodiment, the ER source 302 may not receive the ER-CTS packet 316. In such a scenario, the ER source may be configured to wait for a time duration (e.g., short inter-frame spacing (SIFS)+slot time) and then transmit an ER-CF end packet. In another embodiment, the ER destination may not receive the ER-PPDU packets for a pre-defined time duration or may receive the ER-CF-end packet from the ER source. In such a scenario, the ER destination may transmit the ER-CF-end packet followed by the CF-end packet to the ER source. The ER-CF-end packet and the CF-end packet ordering may be interchanged.

Frame collisions may result from the conventional RTS/CTS mechanism's inability to reserve the channel for longer range. For example, non-ER devices which cannot operate in the ER range may detect the channel as free even if ER transmission is ongoing, which could result in collisions. By reserving the channel for extended range using the second channel reservation scheme 300 to reserve the channel for extended range, frame collisions caused by hidden nodes can be avoided.

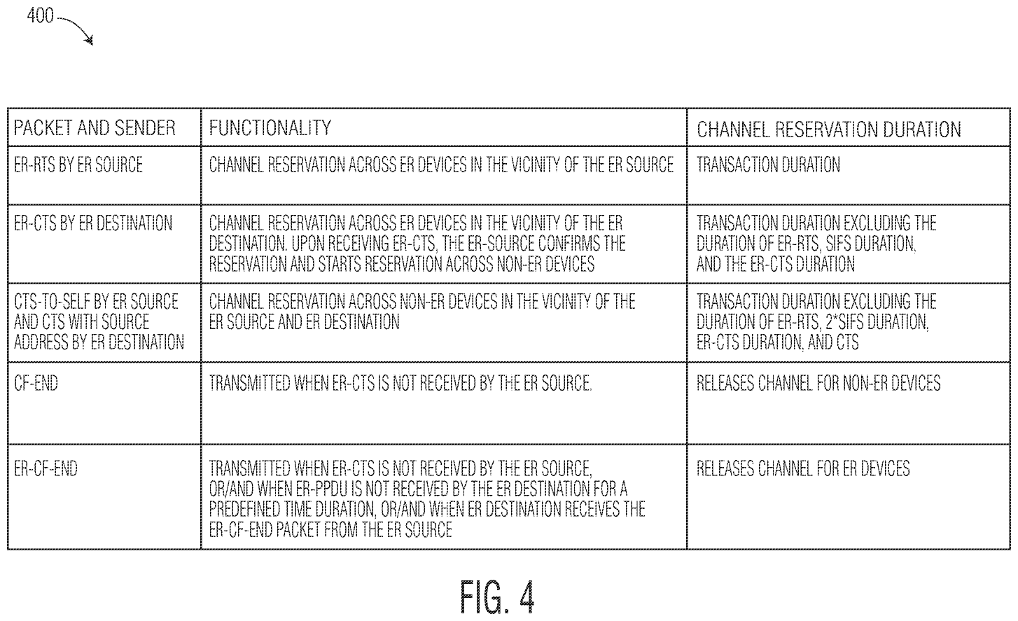

FIG. 4 illustrates a second table 400 corresponding to step-wise summarization of the second channel reservation scheme 300 depicted in FIG. 3 in accordance with an embodiment of the present disclosure. The second table 400 illustrates the packet and the sender, the functionality of each packet, and the channel reservation duration based on each packet for the second channel reservation scheme 300 depicted in FIG. 3. Each row of the table corresponds to one step.

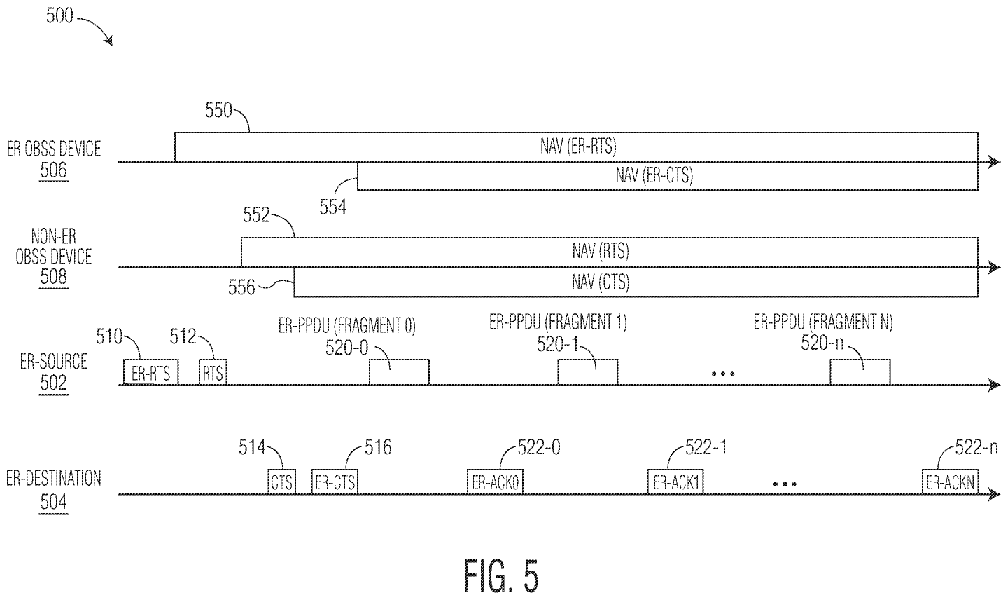

FIG. 5 illustrates a third channel reservation scheme 500 in accordance with an embodiment of the present disclosure. An extended range (ER) source 502 may be required to communicate with an ER destination 504. To enable the communication between the ER source and the ER destination, a transmission channel there between may be reserved. When the transmission channel is reserved for the ER source 502 and the ER destination 504, other devices may perceive the transmission channel to be unavailable for use. In some embodiments, the transmission channel is a wireless transmission channel between the ER source and the ER destination. For example, the transmission channel is the wireless transmission medium between the ER source and the ER destination. In the third channel reservation scheme 500, the ER source 502 may transmit an ER-RTS packet 510 to the ER destination 504. The ER-RTS packet may contain the source address, the destination address, and the transaction duration. Further, one or more ER-OB SS devices 506 in the vicinity of the ER source may be configured to detect the ER-RTS packet transmitted by the ER source and update the NAV 550 of each of the OB SS devices to indicate busy. The ER source may be further configured to transmit an RTS-to-self packet 512. Based on the RTS-to-self packet, one or more non-ER-OBSS devices 508 may be configured to update the status of their NAV 552 based on the value mentioned in the duration field. Further, the ER destination may be configured to transmit a CTS-to-self packet 514, and the non-ER-OB SS devices in the vicinity of the ER destination update the status of their NAV 556 to indicate busy. The ER destination may be further configured to transmit an ER-CTS packet 516 to the ER source, and the ER-OBSS devices in the vicinity of the ER destination update the status of their NAV 554 till the end of the transaction. On receiving the ER-CTS packet from the ER destination, the ER source may determine that the channel is reserved and may transmit the ER-PPDU packet to the ER destination in ‘n+1’ fragments 520-0, . . . , 520-n, where n is a positive integer as described in FIG. 5. Based on the reception of each of the n+1-fragments of the ER-PPDU packet, the ER destination may be configured to transmit ‘n+1’ ER-acknowledgment (ACK) 522-0, . . . , 522-n (also referred to as ER-Ack0, . . . , ER-AckN) for the n+1-fragments of the ER-PPDU packet. In other words, based on receiving an ER-PPDU fragment 1, an ER-ACK1 may be transmitted by the ER destination.

The RTS-to-self packet 512 transmitted by the ER source 502 may include the source address and the transaction duration excluding the SIFS duration and the RTS-to-self duration. The CTS-to-self packet 514 transmitted by the ER destination 504 may include the source address and the transaction duration is such that the channel is reserved till the same time as indicated in the ER-RTS packet 510. The ER-CTS packet 516 transmitted by the ER destination may include the source address of the ER source 502 and the transaction duration may be such that it covers the reservation as per the ER-RTS duration. On receiving the ER-CTS packet from the ER destination, the ER source may determine that the channel is reserved and may transmit the ER-PPDU packet to the ER destination in a similar manner as described in FIG. 1. If ER-CTS is not received at the ER-source till (short inter-frame spacing (SIFS)*3+RTS+CTS+slot time) duration from the end of transmission of ER-RTS, the ER source may similarly transmit CF-end/ER-CF-end as described for FIG. 1. Frame collisions may result from the conventional RTS/CTS

mechanism's inability to reserve the channel for longer range. For example, non-ER devices which cannot operate in the ER range may detect the channel as free even if ER transmission is ongoing, which could result in collisions. By reserving the channel for extended range using the third channel reservation scheme 500 to reserve the channel for extended range, frame collisions caused by hidden nodes can be avoided.

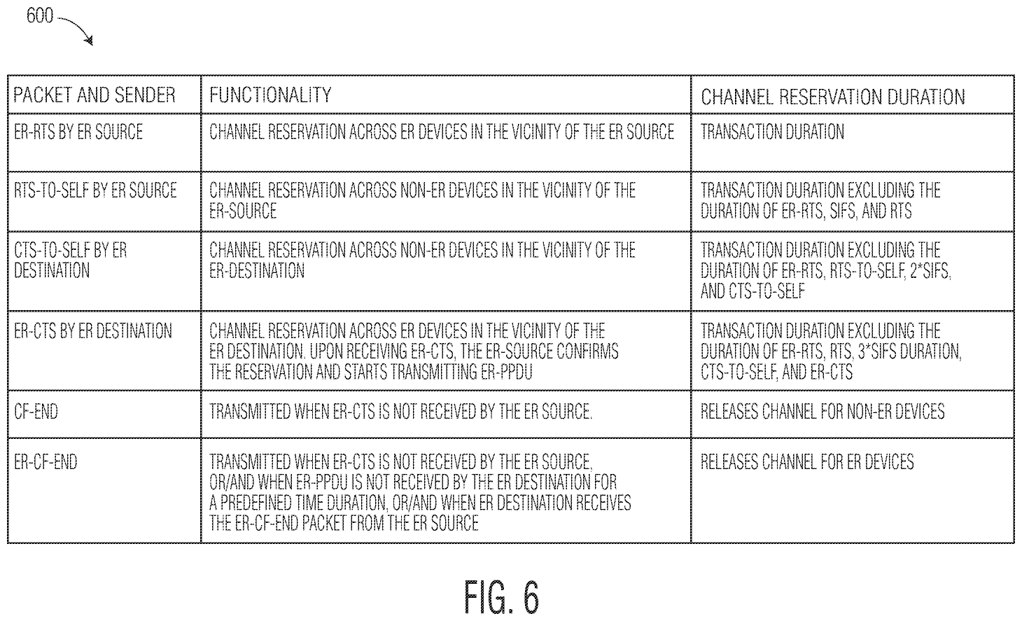

FIG. 6 illustrates a third table 600 corresponding to step-wise summarization of the third channel reservation scheme 500 depicted in FIG. 5 in accordance with an embodiment of the present disclosure. The third table 600 illustrates the packet and the sender, the functionality of each packet, and the channel reservation duration based on each packet for the third channel reservation scheme 500 depicted in FIG. 5. Each row of the table corresponds to one step.

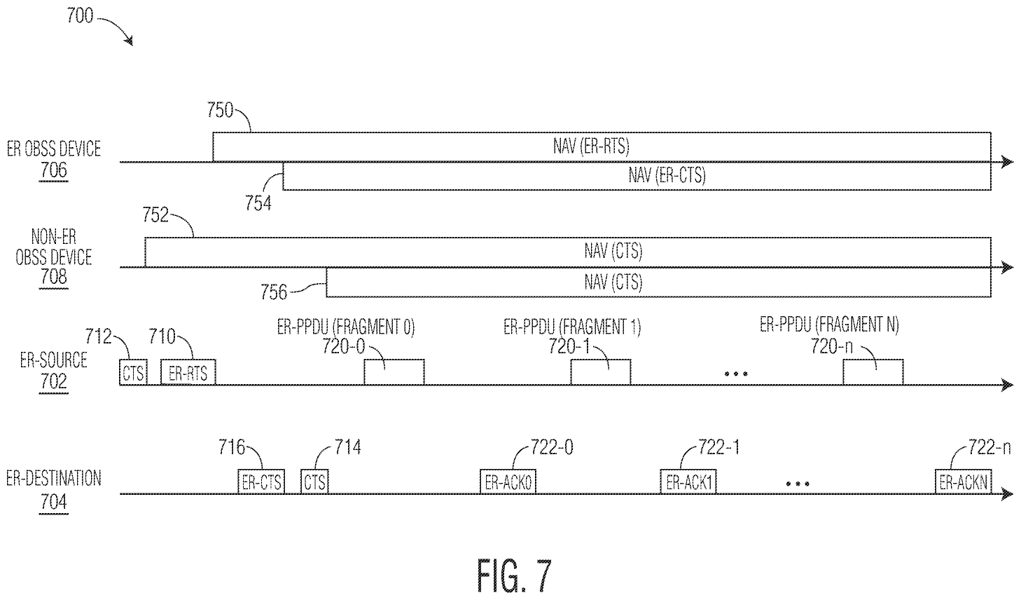

FIG. 7 illustrates a fourth channel reservation scheme 700 in accordance with an embodiment of the present disclosure. An extended range (ER) source 702 may be required to communicate with an ER destination 704. To enable the communication between the ER source and the ER destination, a transmission channel therebetween may be reserved. When the transmission channel is reserved for the ER source 702 and the ER destination 704, other devices may perceive the transmission channel to be unavailable for use. In some embodiments, the transmission channel is a wireless transmission channel between the ER source and the ER destination. For example, the transmission channel is the wireless transmission medium between the ER source and the ER destination. In the fourth channel reservation scheme 700, the ER source 702 may transmit a CTS-to-self packet 712. The CTS-to-self packet may contain the source address and the transaction duration. Further, non-ER devices (e.g., one or more non-ER-OBSS devices 708) in the vicinity of the ER source may be configured to detect the CTS-to-self packet transmitted by the ER source and update the NAV(CTS) 752. The ER source may be further configured to transmit an ER-RTS packet 710 and ER devices (e.g., one or more ER-OBSS devices 706) may be configured to update the status of their NAV (ER-RTS) 750 based on the value mentioned in the duration field. Further, the ER destination 704 may be configured to transmit an ER-CTS packet 716, and the ER-OB SS devices in the vicinity of the ER destination update the status of their NAV 754. The ER destination may be further configured to transmit a CTS packet 714 to the ER source, and the non-ER-OBSS devices in the vicinity of the ER destination update the status of their NAV 756 till the end of the transaction. On receiving the ER-CTS packet from the ER destination, the ER source may determine that the channel is reserved and may transmit the ER-PPDU packet to the ER destination in ‘n+1’ fragments 720-0, . . . , 720-n, where n is a positive integer as described in FIG. 7. Based on the reception of each of the n+1-fragments of the ER-PPDU packet, the ER destination may be configured to transmit ‘n+1’ ER-acknowledgment (ACK) 722-0, . . . , 722-n (also referred to as ER-Ack0, . . . , ER-AckN) for the n+1-fragments of the ER-PPDU packet. In other words, based on receiving an ER-PPDU fragment 1, an ER-ACK1 may be transmitted by the ER destination.

The ER-RTS packet 710 transmitted by the ER source 702 may include the source address, the destination address, and the transaction duration will be the duration in the CTS-to-self packet excluding one SIFS duration and the duration of the ER-RTS packet. The ER-CTS packet 716 transmitted by the ER destination 704 may include the source address and the transaction duration is such that the channel is reserved till the same time as indicated in the ER-RTS packet. The CTS packet 712 transmitted by the ER destination may include the source address of the ER source and the transaction duration may be such that it covers the reservation as per the ER-RTS duration. On receiving the ER-CTS packet from the ER destination, the ER source may determine that the channel is reserved and may transmit the ER-PPDU packet to the ER destination in a similar manner as described in FIG. 1. If ER-CTS is not received at the ER-source within (short inter-frame spacing (SIFS)+slot time) duration from the end of transmission of ER-RTS, the ER source may similarly transmit CF-end/ER-CF-end as described in FIG. 1.

Frame collisions may result from the conventional RTS/CTS mechanism's inability to reserve the channel for longer range. For example, non-ER devices which cannot operate in the ER range may detect the channel as free even if ER transmission is ongoing, which could result in collisions. By reserving the channel for extended range using the fourth channel reservation scheme 700 to reserve the channel for extended range, frame collisions caused by hidden nodes can be avoided.

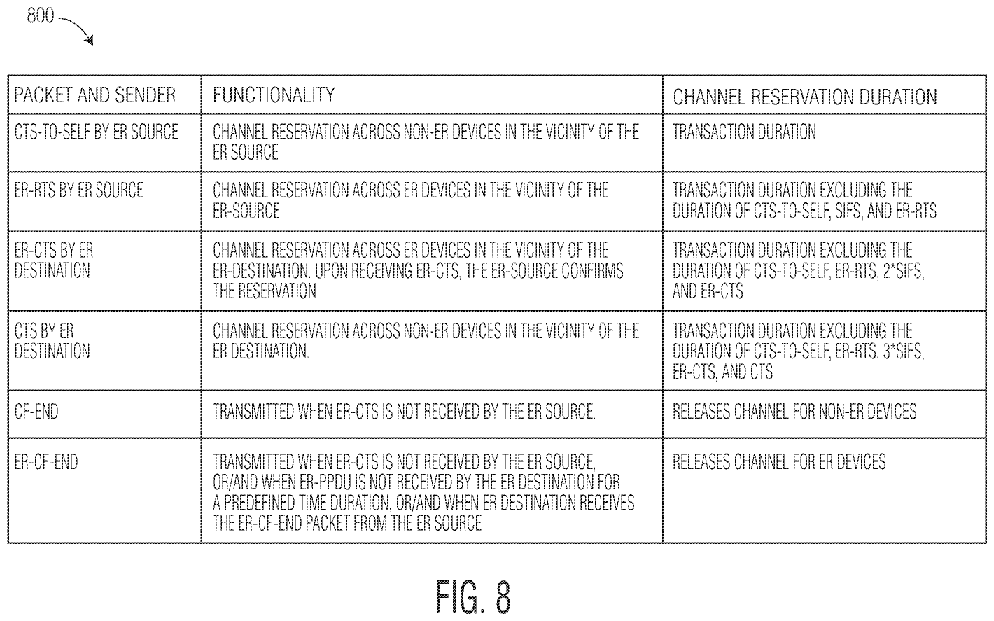

FIG. 8 illustrates a fourth table 800 corresponding to step-wise summarization of the fourth channel reservation scheme 700 depicted in FIG. 7 in accordance with an embodiment of the present disclosure. The fourth table 800 illustrates the packet and the sender, the functionality of each packet, and the channel reservation duration based on each packet for the fourth channel reservation scheme 700 depicted in FIG. 7. Each row of the table corresponds to one step.

The present disclosure further describes two methods for reserving the channel through ongoing traffic. For example, the channel reservation is extended after transmission of one fragment by an ER transmitter. One method utilizes the simultaneous CTS for extending the reservation in the non-ER device, whereas the other utilizes the RTS from ER source and CTS from ER destination for the reservation in non-ER devices. Compared to reserving the channel for the whole transaction, in the two methods, each of the reservations covers exactly one transaction including the Ack packet. For transmission of simultaneous CTS/ER-CTS packets, the contents of each packet must remain the same. Further, the destination must perform pre-compensation for carrier frequency offset and symbol clock error while transmitting the simultaneous CTS/ER-CTS. The pre-compensation uses a value from the previously received ER-RTS PPDU, and if no ER-RTS PPDU was transmitted from the source then the pre-compensation uses a value from the previously received RTS frame PPDU.

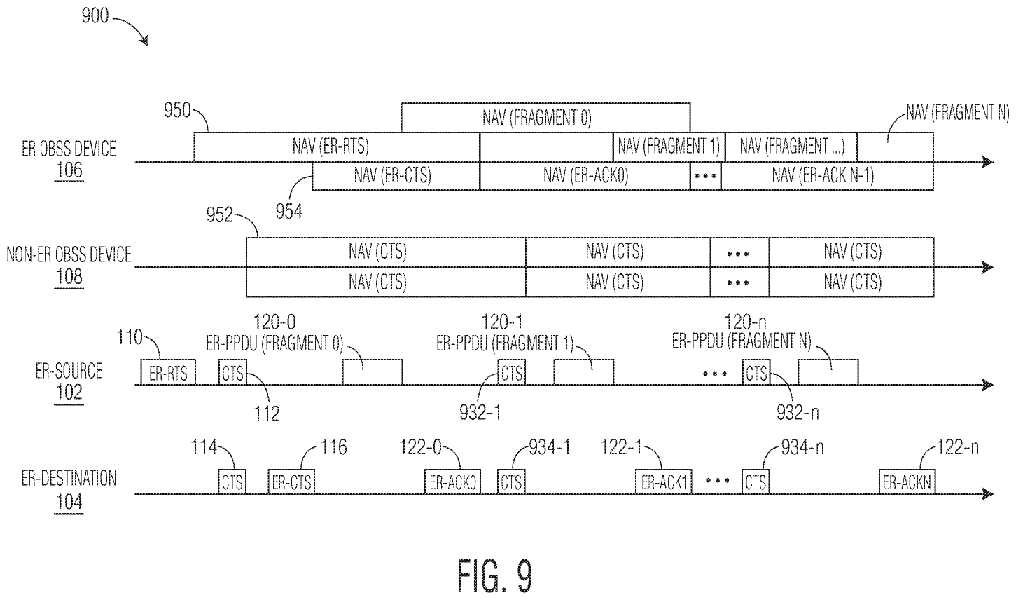

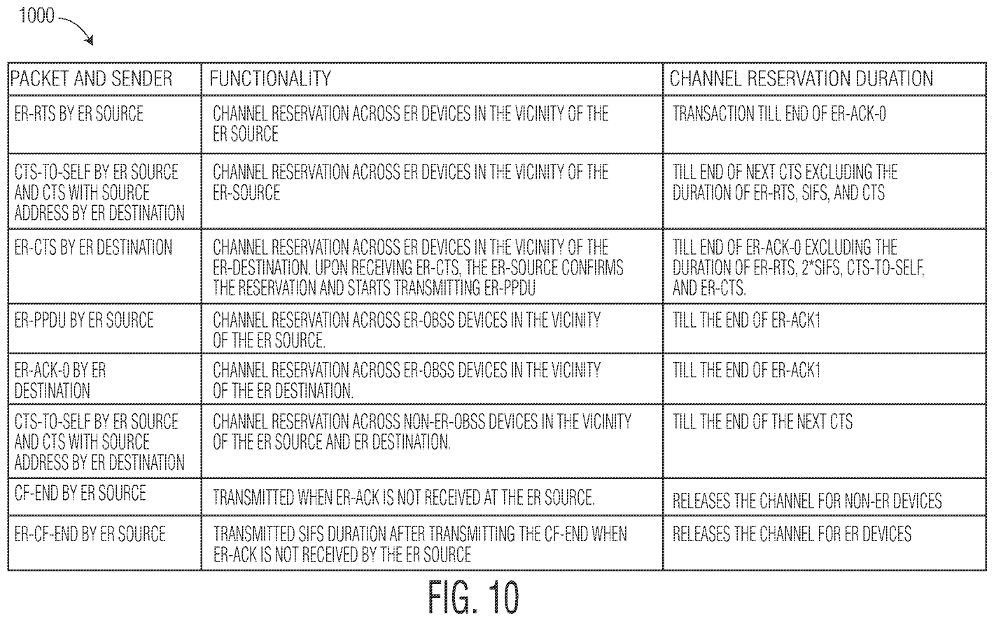

FIG. 9 illustrates a first mechanism 900 that combines a first extension method and the first channel reservation scheme 100 depicted in FIG. 1 in accordance with an embodiment of the present disclosure. The first mechanism 900 may be indicative of extending the channel reservation following the transmission of a first fragment of the ‘n+1’ fragments by the ER source 102. The first extension method may utilize simultaneous CTS packets for extending the channel reservation in the non-ER OB SS devices 108. In FIG. 9, NAV (ER-RTS) 950 corresponds to reservation based on the duration field in the ER-RTS packet 110, whereas NAV (ER-CTS) 954 corresponds to reservation based on the duration field in the ER-CTS packet 116. Further, NAV (fragment i) corresponds to reservation based on the duration in the ER-PPDU (fragment i), whereas NAV (ER-Ack i) corresponds to reservation based on the duration in the ER-Ack i PPDU. NAV (CTS) 952 corresponds to reservation based on the duration from the simultaneous CTS packets 932-1, . . . , 932-n, 934-1, . . . , 934-n. The step-wise summarization of the first mechanism 900 is illustrated in FIG. 10.

FIG. 10 illustrates a fifth table 1000 corresponding to step-wise summarization of the first mechanism 900 depicted in FIG. 9 in accordance with an embodiment of the present disclosure. The fifth table 1000 illustrates the packet and the sender, the functionality of each packet, and the channel reservation duration based on each packet for the first mechanism 900 depicted in FIG. 9. Each row of the table corresponds to one step.

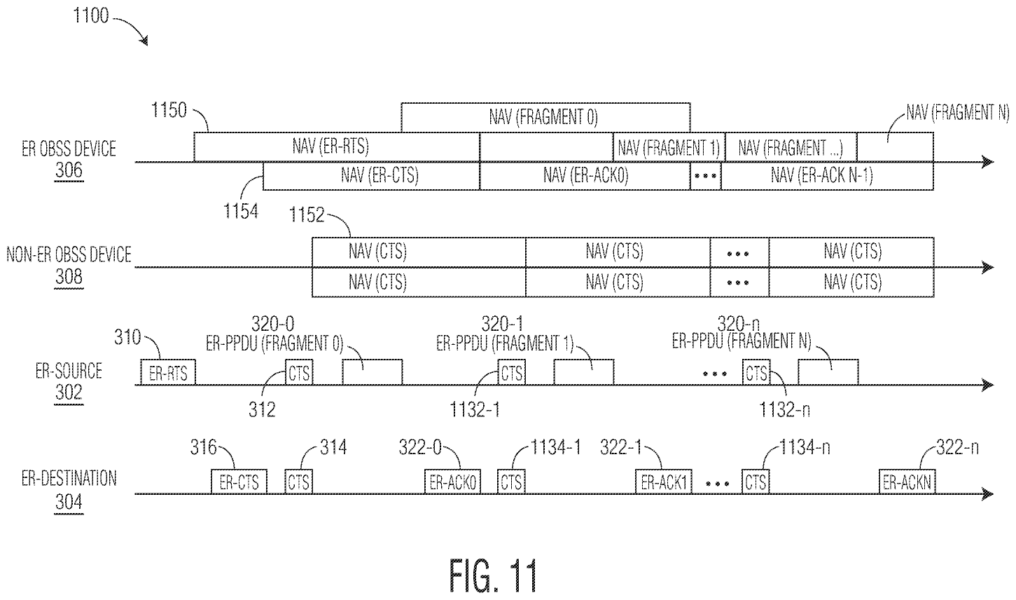

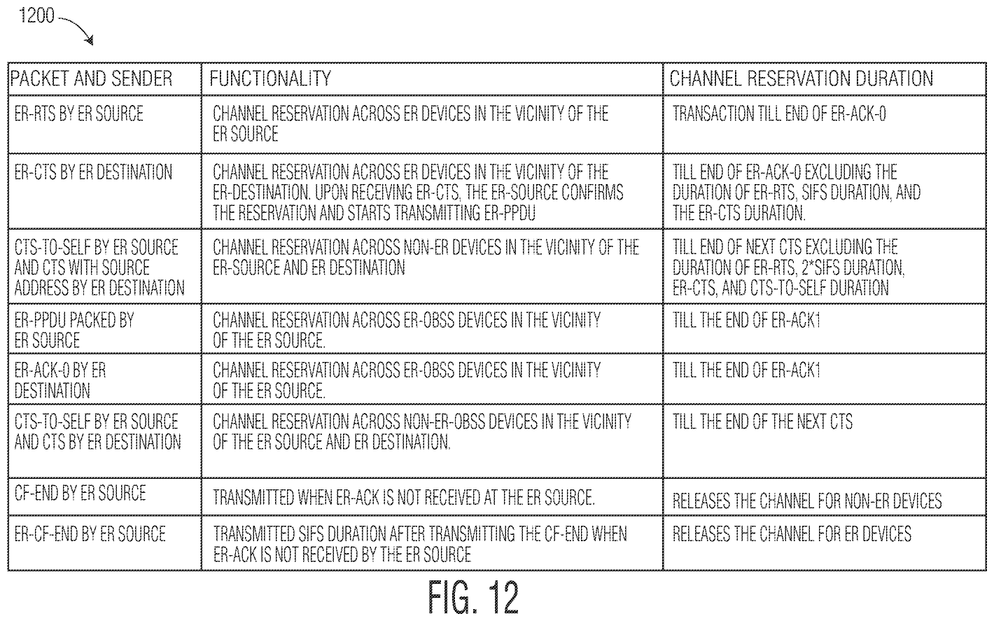

FIG. 11 illustrates a second mechanism 1100 that combines the first extension method and the second channel reservation scheme 300 depicted in FIG. 3 in accordance with an embodiment of the present disclosure. The second mechanism 1100 may be indicative of extending the channel reservation following the transmission of a first fragment of the ‘n+1’ fragments by the ER source 302. The first extension method may utilize simultaneous CTS packets for extending the channel reservation in the non-ER OBSS devices 308. In FIG. 11, NAV (ER-RTS) 1150 corresponds to reservation based on the duration field in the ER-RTS packet 310, whereas NAV (ER-CTS) 1154 corresponds to reservation based on the duration field in the ER-CTS packet 316. Further, NAV (fragment i) corresponds to reservation based on the duration in the ER-PPDU (fragment i), whereas NAV (ER-Ack i) corresponds to reservation based on the duration in the ER-Ack i PPDU. NAV (CTS) 1152 corresponds to reservation based on the duration from the simultaneous CTS packets 1132-1, . . . , 1132-n, 1134-1, . . . , 1134-n. The step-wise summarization of the second mechanism 1100 is illustrated in FIG. 12.

FIG. 12 illustrates a sixth table 1200 corresponding to step-wise summarization of the second mechanism 1100 depicted in FIG. 11 in accordance with an embodiment of the present disclosure. The sixth table 1200 illustrates the packet and the sender, the functionality of each packet, and the channel reservation duration based on each packet for the second mechanism 1100 depicted in FIG. 11. Each row of the table corresponds to one step.

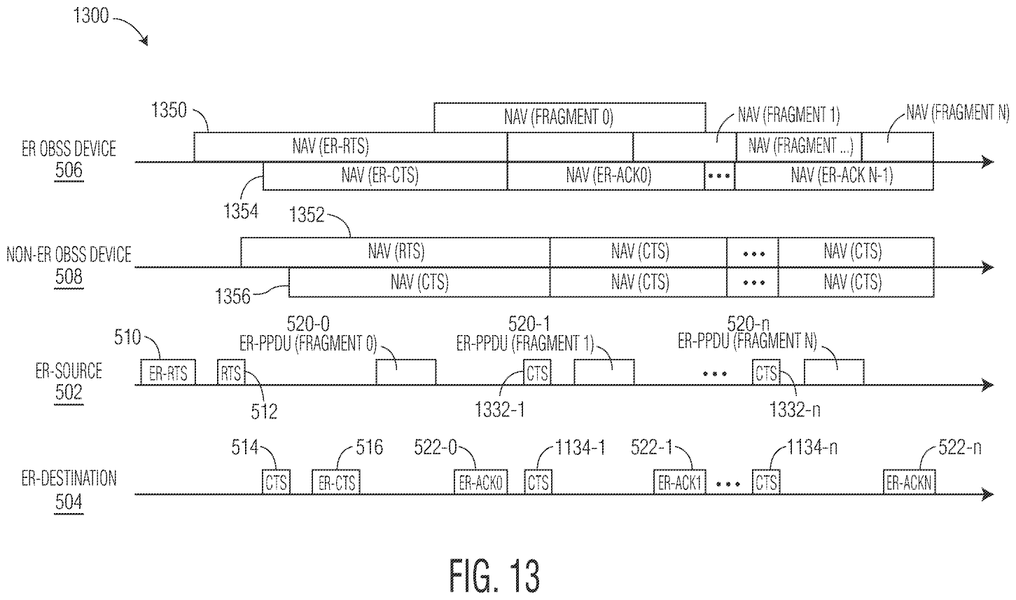

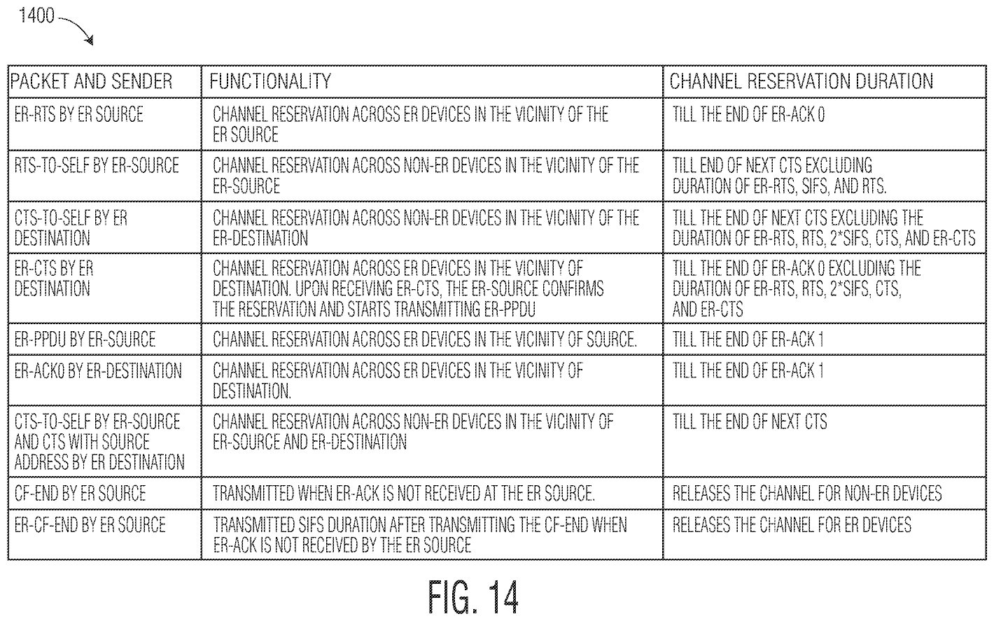

FIG. 13 illustrates a third mechanism 1300 that combines the first extension method and the third channel reservation scheme 500 depicted in FIG. 5 in accordance with an embodiment of the present disclosure. The third mechanism 1300 may be indicative of extending the channel reservation following the transmission of a first fragment of the ‘n+1’ fragments by the ER source 502. The first extension method may utilize simultaneous CTS packets for extending the channel reservation in the non-ER OBSS devices 508. In FIG. 13, NAV (ER-RTS) 1350 corresponds to reservation based on the duration field in the ER-RTS packet 510, whereas NAV (ER-CTS) 1354 corresponds to reservation based on the duration field in the ER-CTS packet 516. Further, NAV (fragment i) corresponds to reservation based on the duration in the ER-PPDU (fragment i), whereas NAV (ER-Ack i) corresponds to reservation based on the duration in the ER-Ack i PPDU. NAV (RTS) NAV (CTS) 1352, 1356 correspond to reservation based on the duration from the RTS packet 512 and the simultaneous CTS packets 1332-1, . . . , 1332-n, 1334-1, . . . , 1334-n. The step-wise summarization of the third mechanism 1300 is illustrated in FIG. 14.

FIG. 14 illustrates a seventh table 1400 corresponding to step-wise summarization of the third mechanism 1300 depicted in FIG. 13 in accordance with an embodiment of the present disclosure. The seventh table 1400 illustrates the packet and the sender, the functionality of each packet, and the channel reservation duration based on each packet for the third mechanism 1300 depicted in FIG. 13. Each row of the table corresponds to one step.

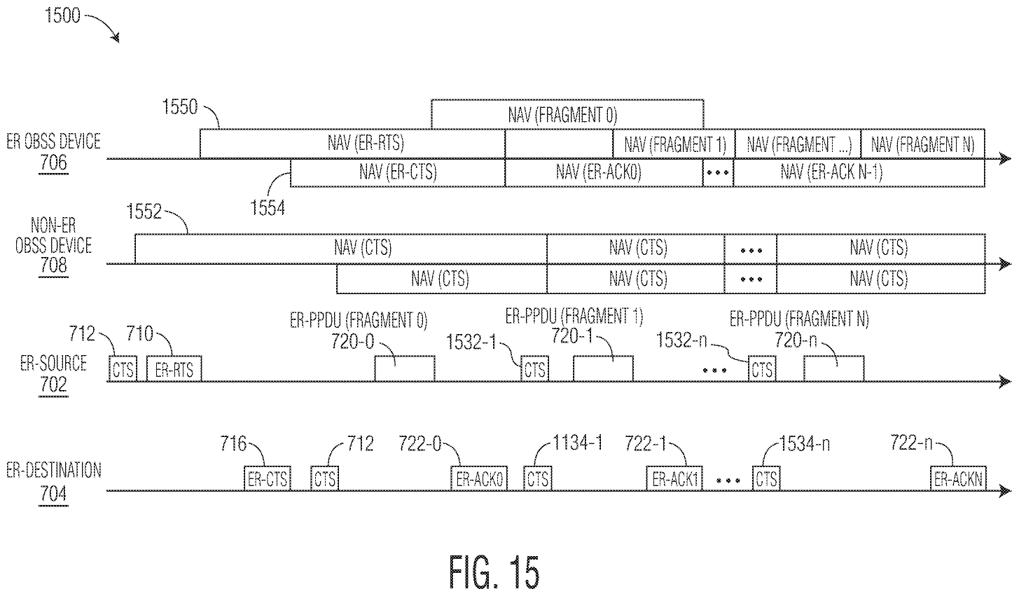

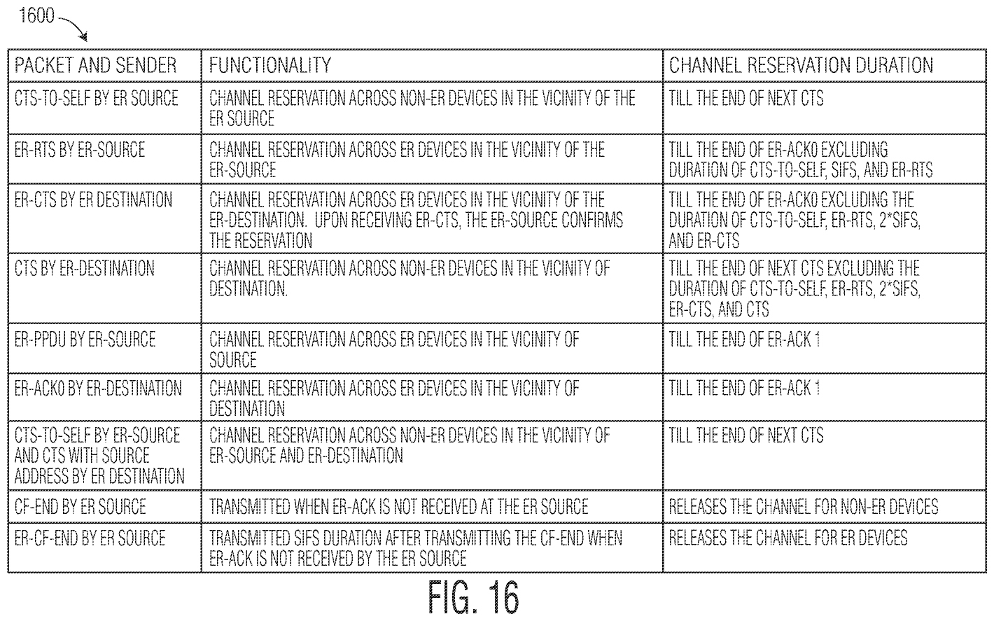

FIG. 15 illustrates a fourth mechanism 1500 that combines the first extension method and the fourth channel reservation scheme 700 depicted in FIG. 7 in accordance with an embodiment of the present disclosure. The fourth mechanism 1500 may be indicative of extending the channel reservation following the transmission of a first fragment of the ‘n+1’ fragments by the ER source 702. The first extension method may utilize simultaneous CTS packets for extending the channel reservation in the non-ER OBSS devices 708. In FIG. 15, NAV (ER-RTS) 1550 corresponds to reservation based on the duration field in the ER-RTS packet 710, whereas NAV (ER-CTS) 1554 corresponds to reservation based on the duration field in the ER-CTS packet 716. Further, NAV (fragment i) corresponds to reservation based on the duration in the ER-PPDU (fragment i), whereas NAV (ER-Ack i) corresponds to reservation based on the duration in the ER-Ack i PPDU. NAV (CTS) 1552 corresponds to reservation based on the duration from the simultaneous CTS packets 1532-1, . . . , 1532-n, 1534-1, . . . , 1534-n. The step-wise summarization of the fourth mechanism 1500 is illustrated in FIG. 16.

FIG. 16 illustrates an eighth table 1600 corresponding to step-wise summarization of the fourth mechanism 1500 depicted in FIG. 15 in accordance with an embodiment of the present disclosure. The eighth table 1600 illustrates the packet and the sender, the functionality of each packet, and the channel reservation duration based on each packet for the fourth mechanism 1500 depicted in FIG. 15. Each row of the table corresponds to one step.

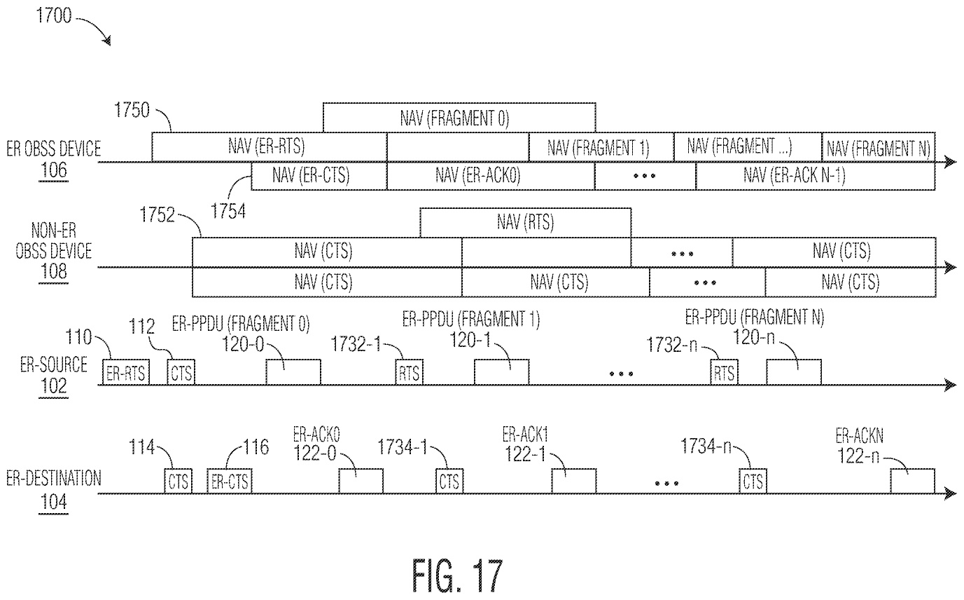

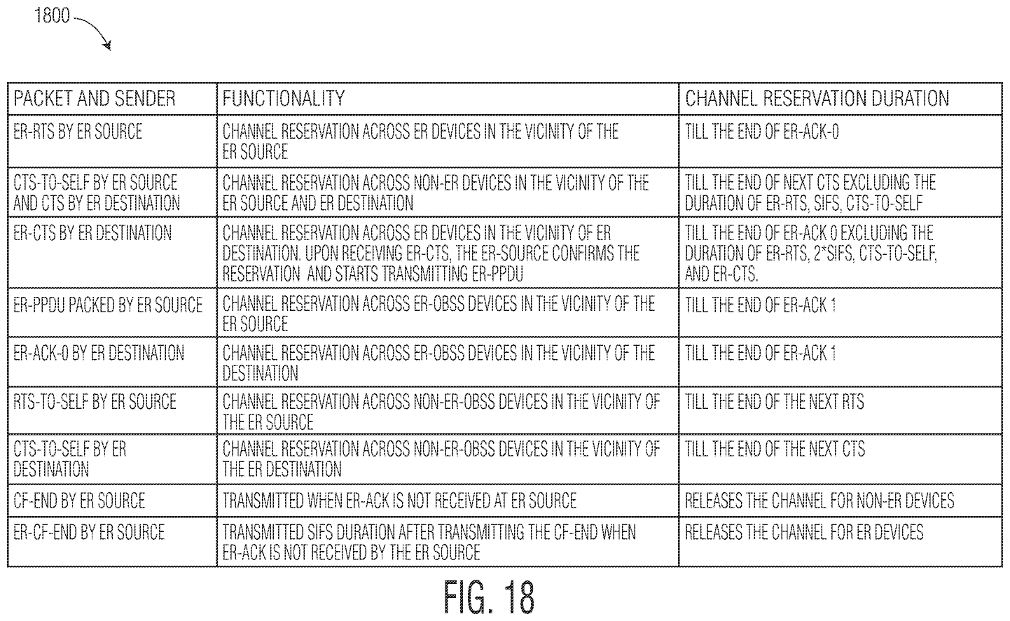

FIG. 17 illustrates a fifth mechanism 1700 that combines a second extension method and the first channel reservation scheme 100 depicted in FIG. 1 in accordance with an embodiment of the present disclosure. The second extension method may utilize the RTS packet from the ER source 102 and the CTS packet from the ER destination 104 for extending the channel reservation in the non-ER OBSS devices 108. The fifth mechanism 1700 may be indicative of extending the channel reservation following the transmission of a first fragment of the ‘n+1’ fragments by the ER source 102. In FIG. 17, NAV (ER-RTS) 1750 corresponds to reservation based on the duration field in the ER-RTS packet 110, whereas NAV (ER-CTS) 1754 corresponds to reservation based on the duration field in the ER-CTS packet 116. Further, NAV (fragment i) corresponds to reservation based on the duration in the ER-PPDU (fragment i), whereas NAV (ER-Ack i) corresponds to reservation based on the duration in the ER-Ack i PPDU. NAV (CTS) 1752 corresponds to reservation based on the duration from the RTS packets 1732-1, . . . , 1732-n and CTS packets 1734-1, . . . , 1734-n. The step-wise summarization of the fifth mechanism 1700 is illustrated in FIG. 18.

FIG. 18 illustrates a ninth table 1800 corresponding to step-wise summarization of the fifth mechanism 1700 depicted in FIG. 17 in accordance with an embodiment of the present disclosure. The ninth table 1800 illustrates the packet and the sender, the functionality of each packet, and the channel reservation duration based on each packet for the fifth mechanism 1700 depicted in FIG. 17. Each row of the table corresponds to one step.

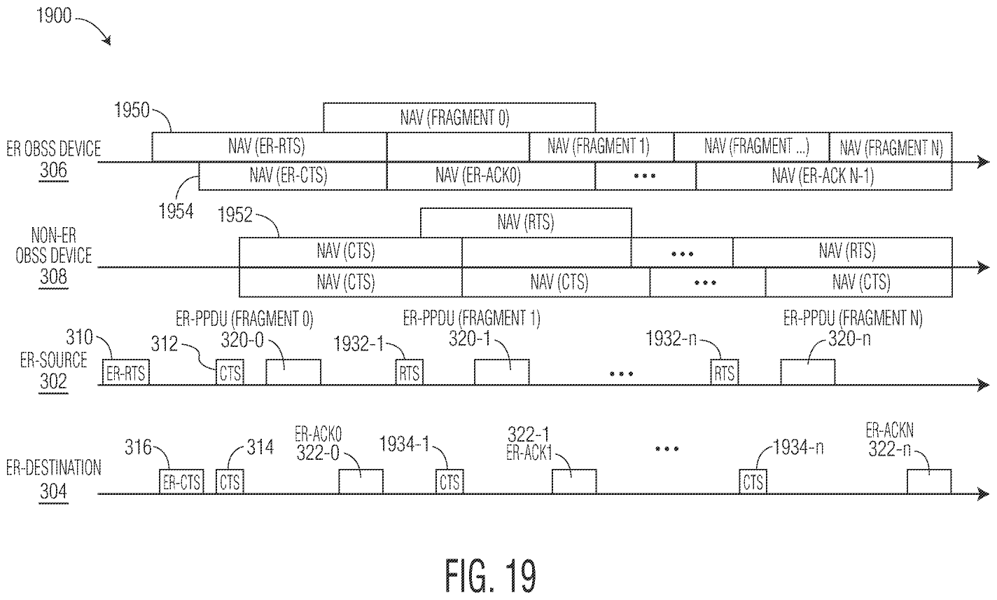

FIG. 19 illustrates a sixth mechanism 1900 that combines the second extension method and the second channel reservation scheme 300 depicted in FIG. 3 in accordance with an embodiment of the present disclosure. The second extension method may utilize the RTS packet from the ER source 302 and the CTS packet from the ER destination 304 for extending the channel reservation in the non-ER OB SS devices 308. The sixth mechanism 1900 may be indicative of extending the channel reservation following the transmission of a first fragment of the ‘n+1’ fragments by the ER source 302. In FIG. 19, NAV (ER-RTS) 1950 corresponds to reservation based on the duration field in the ER-RTS packet 310, whereas NAV (ER-CTS) 1954 corresponds to reservation based on the duration field in the ER-CTS packet 316. Further, NAV (fragment i) corresponds to reservation based on the duration in the ER-PPDU (fragment i), whereas NAV

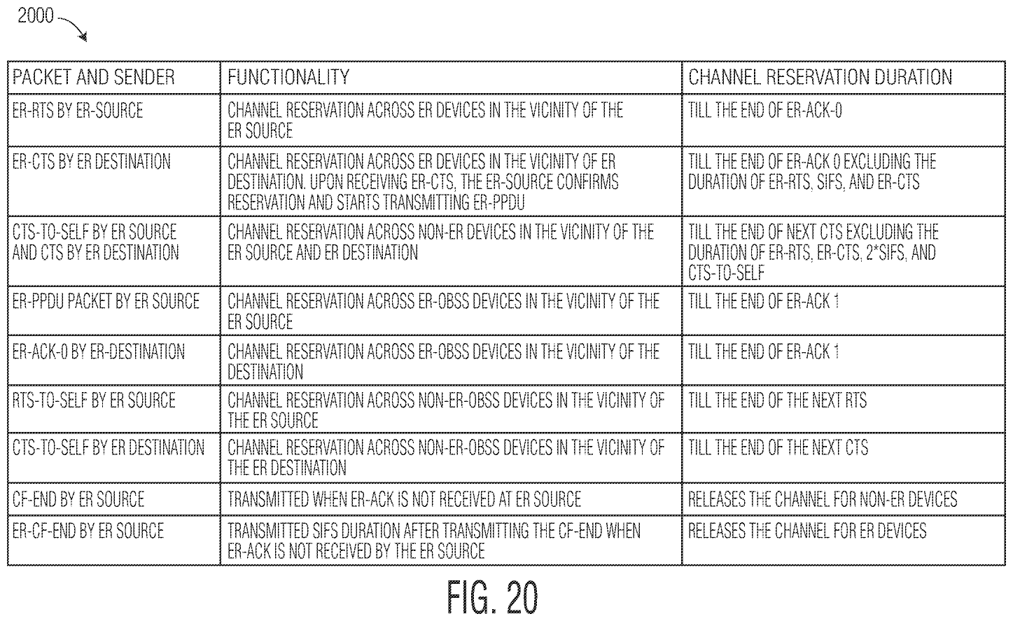

(ER-Ack i) corresponds to reservation based on the duration in the ER-Ack i PPDU. NAV (CTS) 1952 corresponds to reservation based on the duration from the RTS packets 1932-1, . . . , 1932-n and CTS packets 1934-1, . . . , 1934-n. The step-wise summarization of the sixth mechanism 1900 is illustrated in FIG. 20.

FIG. 20 illustrates a tenth table 2000 corresponding to step-wise summarization of the sixth mechanism 1900 depicted in FIG. 19 in accordance with an embodiment of the present disclosure. The tenth table 2000 illustrates the packet and the sender, the functionality of each packet, and the channel reservation duration based on each packet for the sixth mechanism 1900 depicted in FIG. 19. Each row of the table corresponds to one step.

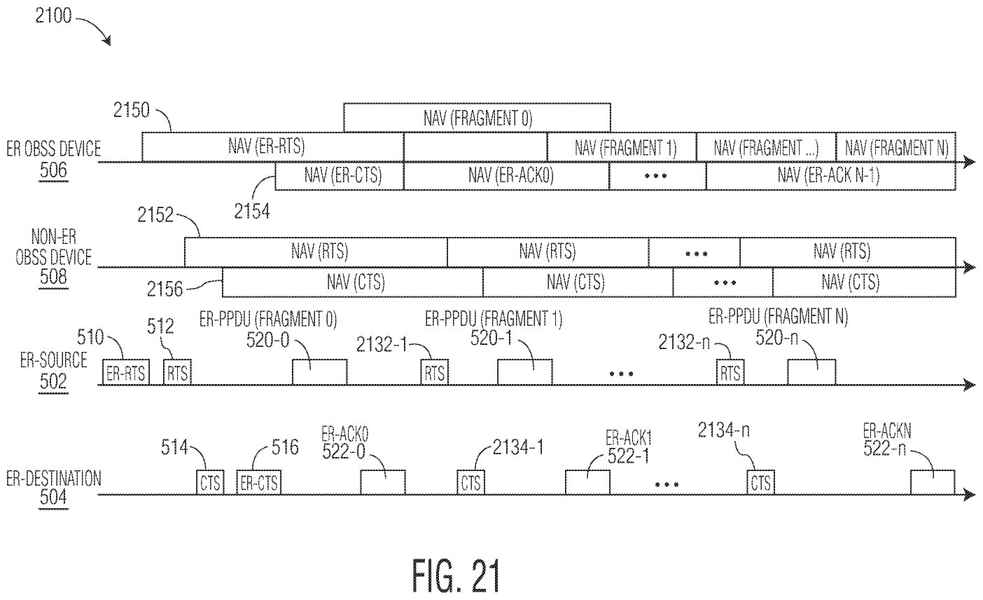

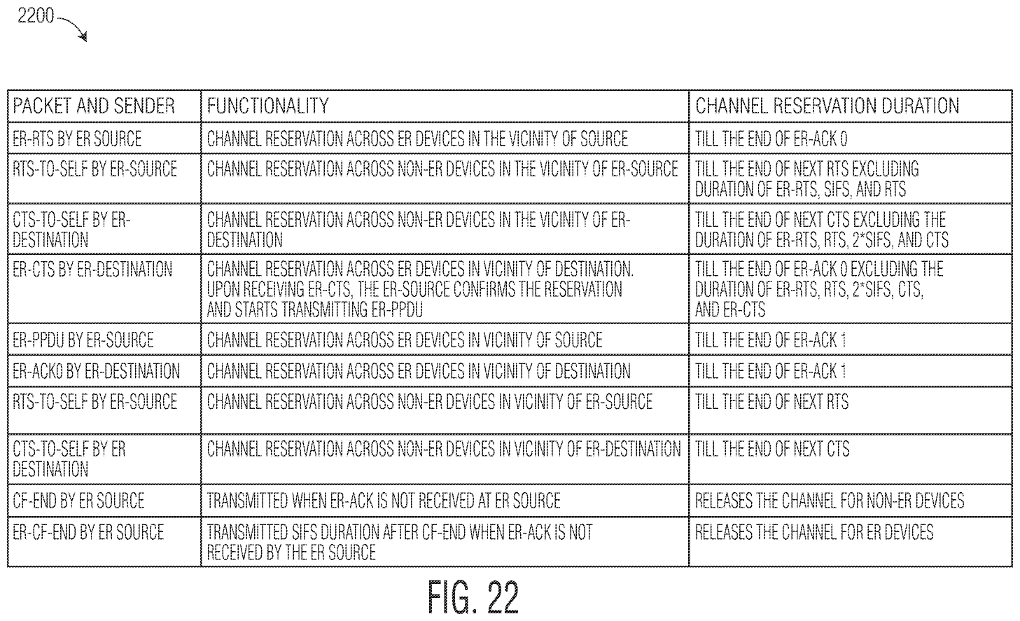

FIG. 21 illustrates a seventh mechanism 2100 that combines the second extension method and the third channel reservation scheme 500 depicted in FIG. 5 in accordance with an embodiment of the present disclosure. The second extension method may utilize the RTS packet from the ER source 502 and the CTS packet from the ER destination 504 for extending the channel reservation in the non-ER OB SS devices 508. The seventh mechanism 2100 may be indicative of extending the channel reservation following the transmission of a first fragment of the ‘n+1’ fragments by the ER source 502. In FIG. 21, NAV (ER-RTS) 2150 corresponds to reservation based on the duration field in the ER-RTS packet 510, whereas NAV (ER-CTS) 2154 corresponds to reservation based on the duration field in the ER-CTS packet 516. Further, NAV (fragment i) corresponds to reservation based on the duration in the ER-PPDU (fragment i), whereas NAV (ER-Ack i) corresponds to reservation based on the duration in the ER-Ack i PPDU. NAV (RTS) 2152 and NAV (CTS) 2156 correspond to reservation based on the duration from the RTS packets 2132-1, . . . , 2132-n and CTS packets 2134-1, . . . , 2134-n. The step-wise summarization of the seventh mechanism 2100 is illustrated in FIG. 22.

FIG. 22 illustrates an eleventh table 2200 corresponding to step-wise summarization of the seventh mechanism 2100 depicted in FIG. 21 in accordance with an embodiment of the present disclosure. The eleventh table 2200 illustrates the packet and the sender, the functionality of each packet, and the channel reservation duration based on each packet for the seventh mechanism 2100 depicted in FIG. 21. Each row of the table corresponds to one step.

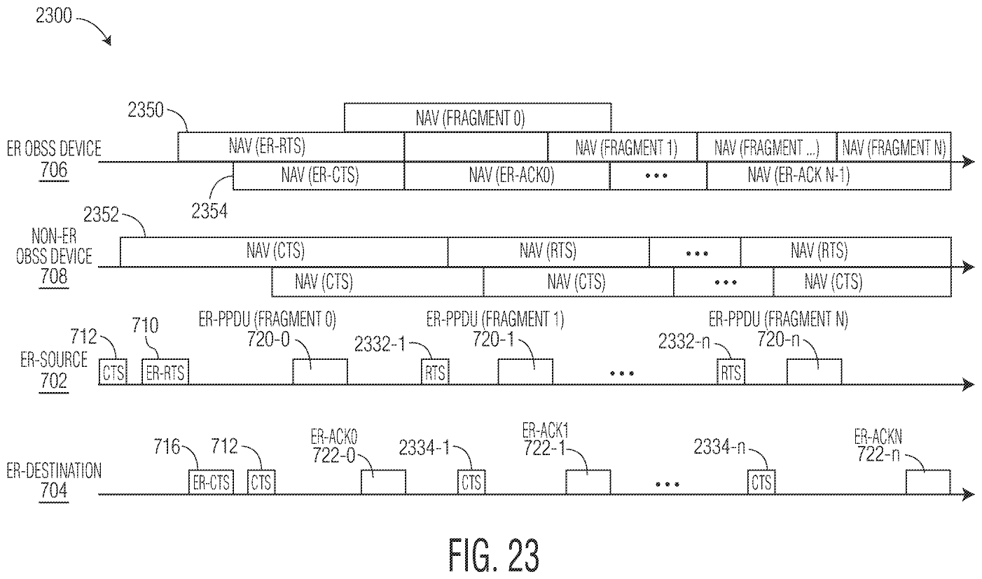

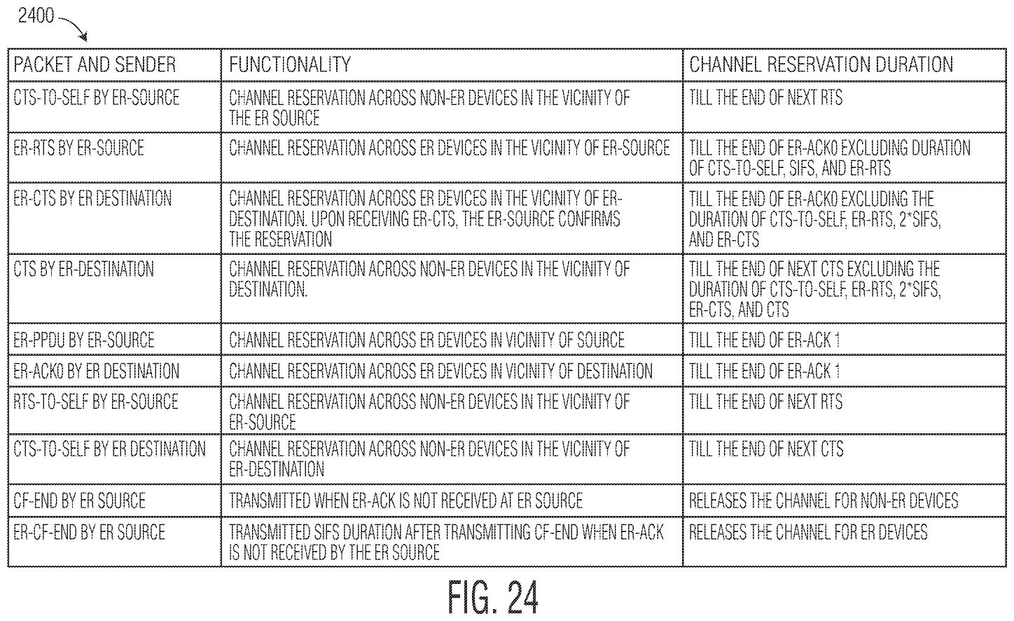

FIG. 23 illustrates an eighth mechanism 2300 that combines the second extension method and the fourth channel reservation scheme 700 depicted in FIG. 7 in accordance with an embodiment of the present disclosure. The second extension method may utilize the RTS packet from the ER source 702 and the CTS packet from the ER destination 704 for extending the channel reservation in the non-ER OB SS devices 708. The eighth mechanism 2300 may be indicative of extending the channel reservation following the transmission of a first fragment of the ‘n+1’ fragments by the ER source 702. In FIG. 23, NAV (ER-RTS) 2350 corresponds to reservation based on the duration field in the ER-RTS packet 710, whereas NAV (ER-CTS) 2354 corresponds to reservation based on the duration field in the ER-CTS packet 716. Further, NAV (fragment i) corresponds to reservation based on the duration in the ER-PPDU (fragment i), whereas NAV (ER-Ack i) corresponds to reservation based on the duration in the ER-Ack i PPDU. NAV (CTS) 2352 corresponds to reservation based on the duration from the RTS packets 2332-1, . . . , 2332-n and CTS packets 2334-1, . . . , 2334-n. The step-wise summarization of the eighth mechanism 2300 is illustrated in FIG. 24.

FIG. 24 illustrates a twelfth table 2400 corresponding to step-wise summarization of the eighth mechanism 2300 depicted in FIG. 23 in accordance with an embodiment of the present disclosure. The twelfth table 2400 illustrates the packet and the sender, the functionality of each packet, and the channel reservation duration based on each packet for the eighth mechanism 2300 depicted in FIG. 23. Each row of the table corresponds to one step.

The present disclosure further describes channel reservation schemes for non-ER packet transmission when one of the device support ER packet processing.

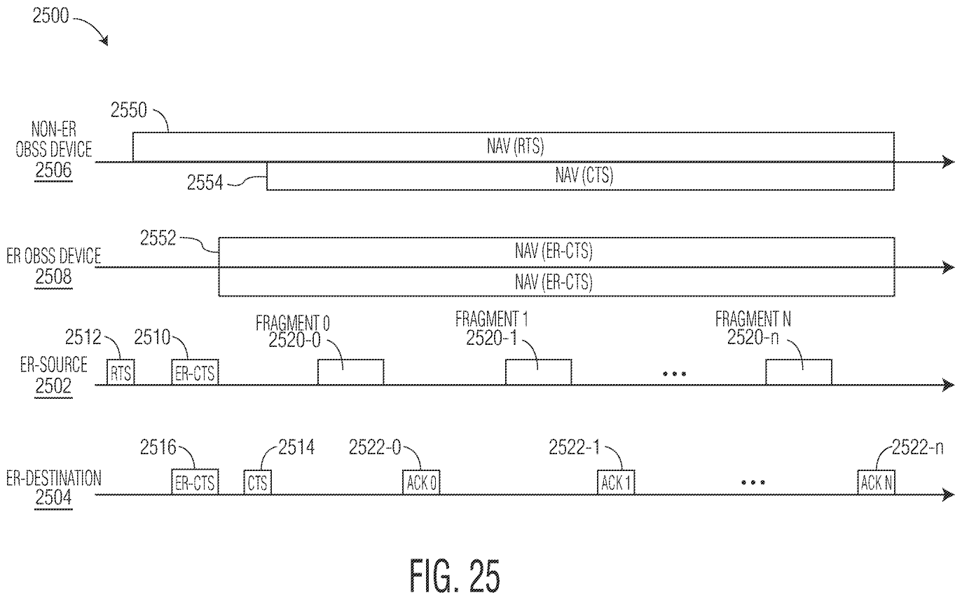

FIG. 25 illustrates a fifth channel reservation scheme 2500 in accordance with an embodiment of the present disclosure. The fifth channel reservation scheme 2500 indicates the channel reservation scheme between an ER source 2502 and an ER destination 2504 for non-ER packet transmission. In some embodiments, the transmission channel is a wireless transmission channel between the ER source 2502 and the ER destination 2504. The transmission of the non-ER packet may be executed using one of the first, second, third, and fourth channel reservation schemes 100, 300, 500, and 700 depicted in FIGS. 1, 3, 5, and 7 by interchanging the ER packets with the non-ER packets. The fifth channel reservation scheme 2500 illustrated in FIG. 25 corresponds to the transmission of the non-ER packet after channel reservation similar to the first channel reservation scheme 100 after interchanging non-ER and ER-frames. For example, the RTS packet 2512 is transmitted by the ER source instead of the ER-RTS packet. Further, the ACK packet 2522-0, . . . , 2522-n, n is a positive integer, is transmitted by the ER destination instead of the ER-ACK packet. In the fifth channel reservation scheme 2500, one or more ER OB SS devices 2506 may be configured to detect the RTS packet transmitted by the ER source 2502 and update the network allocation vector (NAV) (RTS) 2550 thereof to indicate busy. The ER source 2502 may transmit an ER-CTS packet 2510 and the ER destination 2504 may transmit an ER-CTS packet 2516. Based on the ER-CTS packet 2510 and/or the ER-CTS packet 2516, one or more non-ER OB SS devices 2508 may be configured to update the status of their NAV (ER-CTS) 2552 to indicate busy. Additionally, the ER destination may be configured to transmit a CTS packet 2514 and the one or more ER OBSS devices 2506 may be configured to detect the CTS packet 2514 and update the network allocation vector (NAV) (RTS) 2554 thereof to indicate busy. On receiving the CTS packet 2514 from the ER destination 2504, the ER source 2502 may determine that the transmission channel is reserved and may transmit a physical layer protocol data unit (PPDU) packet to the ER destination in ‘n+1’ fragments 2520-0, . . . , 2520-n, where n is a positive integer. Based on the reception of each of the n+1-fragments of the PPDU packet, the ER destination may be configured to transmit ‘n+1’ acknowledgment (ACK) 2522-0, . . . , 2522-n (also referred to as Ack0, AckN) for the n+l-fragments of the PPDU packet.

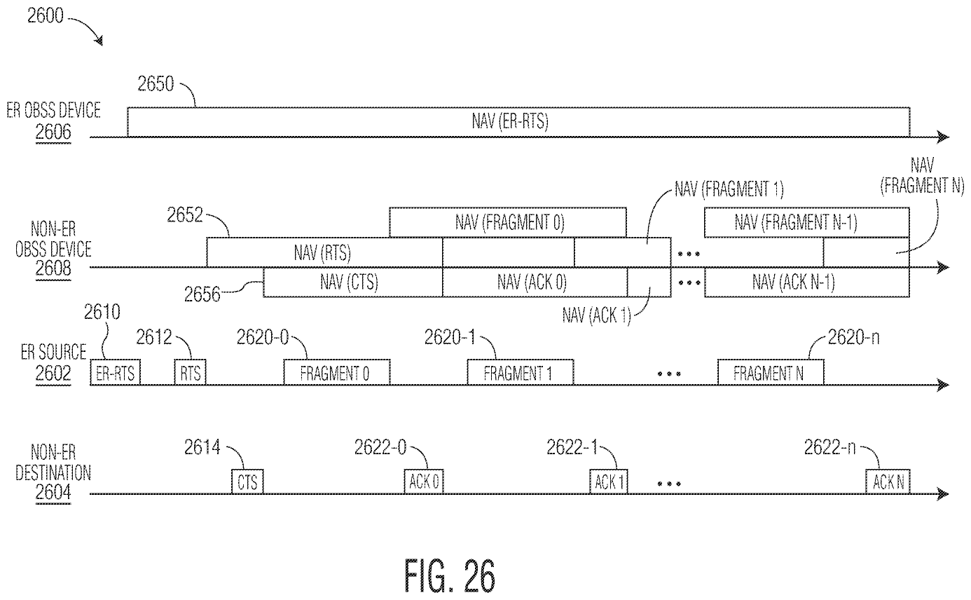

FIG. 26 illustrates a sixth channel reservation scheme 2600 in accordance with an embodiment of the present disclosure. The sixth channel reservation scheme 2600 may indicate the channel reservation for transmission of an ER packet between an ER source 2602 and a non-ER destination 2604. In some embodiments, the transmission channel is a wireless transmission channel between the ER source 2602 and the non-ER destination 2604. The ER source may transmit the ER-RTS packet 2610 containing the source address as both the receiver address (RA) and transmitter address (TA) to set the NAV of ER devices around the source. Further, the ER source may transmit the RTS packet 2612 including RA as the non-ER destination address and TA as the ER source address. In response to the RTS packet, the non-ER destination may transmit the CTS packet 26 14 containing the address as mentioned in the TA field of the RTS packet. Alternatively, the ER source may not transmit the ER-RTS packet. The ER source may directly transmit the RTS packet and the non-ER destination may transmit, in response to the RTS, the CTS packet to the ER source. In such a scenario, the transmission may execute the same sequence as the conventional RTS-CTS scheme between non-ER devices. Further, the ER source may not process any ER packet till the completion of the transaction. In the sixth channel reservation scheme 2600, one or more ER OBSS devices 2606 may be configured to detect the ER-RTS packet transmitted by the ER source 2602 and update the network allocation vector (NAV) (ER-RTS) 2650 thereof to indicate busy. Based on the RTS packet 2612 and/or the CTS packet 2614, one or more non-ER OBSS devices 2608 may be configured to update the status of their NAV (RTS) 2652 and NAV (CTS) 2656 to indicate busy. On receiving the CTS packet 2614 from the non-ER destination 2604, the ER source 2602 may determine that the transmission channel is reserved and may transmit a physical layer protocol data unit (PPDU) packet to the non-ER destination in ‘n+1’ fragments 2620-0, . . . , 2620-n, where n is a positive integer. Based on the reception of each of the n+1-fragments of the PPDU packet, the non-ER destination may be configured to transmit ‘n+1’ acknowledgment (ACK) 2622-0, . . . , 2622-n (also referred to as Ack0, . . . , AckN) for the n+1-fragments of the PPDU packet.

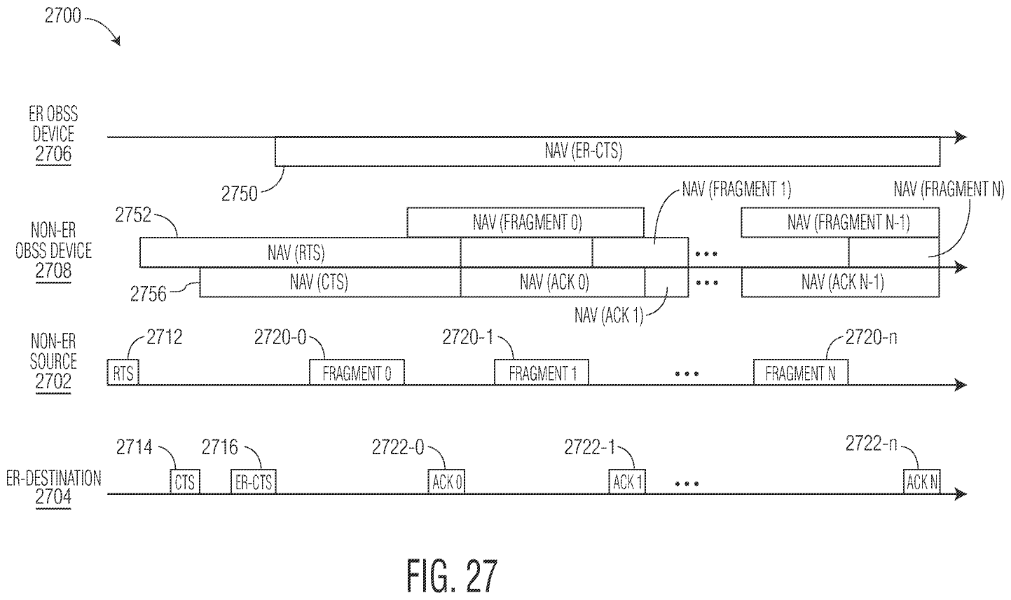

FIG. 27 illustrates a seventh channel reservation scheme 2700 in accordance with an embodiment of the present disclosure. The seventh channel reservation scheme 2700 may indicate the channel reservation for a non-ER packet between a non-ER source 2702 and an ER destination 2704. In some embodiments, the transmission channel is a wireless transmission channel between the non-ER source 2702 and the ER destination 2704. The non-ER source may transmit the RTS packet 2712 that includes RA as the ER destination address and the TA as the non-ER source address. The ER destination may further transmit, in response to the RTS packet, the CTS packet 2714 that includes the address included as TA in the RTS packet. Further, the ER destination may transmit the ER-CTS packet 2716 that includes the address of the ER destination to set the NAV of ER devices around the destination. Alternatively, the non-ER source may transmit the RTS packet and the ER destination may transmit the CTS packet in response to the RTS packet. In other words, no ER-CTS packets are transmitted. In such a scenario, the transmission may execute the same sequence as the conventional RTS-CTS scheme between non-ER devices. Further, the ER destination may not process any ER packet till the completion of the transaction. In the seventh channel reservation scheme 2700, one or more ER OBSS devices 2706 may be configured to detect the ER-CTS packet transmitted by the ER destination and update the network allocation vector (NAV) (ER-CTS) 2750 thereof to indicate busy. Based on the RTS packet 2712 and/or the CTS packet 2714, one or more non-ER OB SS devices 2708 may be configured to update the status of their NAV (RTS) 2752 and NAV (CTS) 2756 to indicate busy. On receiving the ER-CTS packet 2716 from the ER destination 2704, the non-ER source 2702 may determine that the transmission channel is reserved and may transmit a physical layer protocol data unit (PPDU) packet to the ER destination in ‘n+1’ fragments 2720-0, . . . , 2720-n, where n is a positive integer. Based on the reception of each of the n+1-fragments of the PPDU packet, the ER destination may be configured to transmit ‘n+1’ acknowledgment (ACK) 2722-0, . . . , 2722-n (also referred to as Ack0, . . . , AckN) for the n+1-fragments of the PPDU packet.

The scope of the present disclosure is not limited to a single ER destination. In various embodiments of the present disclosure, multiple ER destinations may be present. In such scenarios, simultaneous CTS or ER-CTS is transmitted to/from all ER destinations. Further, in the third channel reservation scheme 500, for multiple ER destinations, when CTS is transmitted individually, either all ER destinations transmit CTS/ER-CTS simultaneously or each ER destination transmits CTS/ER-CTS sequentially with each CTS/ER-CTS separated by the SIFS duration. When the ER source receives at least one ER-CTS packet for ER transmission reservation or a CTS packet for non-ER transmission, the ER source may not send the CF-end packet and ER-CF-end packet and continue the ER transmission. The CF-end packet and the ER-CF-end packet may be sent only when none of the ER-CTS/CTS packets are received.

The present disclosure corresponds to reserving the channel using a single set of RTS/CTS procedures. In some embodiments, the following sequence of operations is considered when a single transmitter is trying to communicate with a single receiver:
1. ER-RTS->Simultaneous CTS->ER-CTS
2. ER-RTS->ER-CTS->Simultaneous CTS
3. ER-RTS->RTS->CTS->ER-CTS
4. CTS-to-self->ER-RTS->ER-CTS->CTS
   If the channel reservation is not successful, CF-End and ER-CF-end packets are used to release the channel. In some embodiments, the following sequence of operations are considered when a single transmitter (transmitter is also referred to as Tx) is trying to communicate with multiple receivers (receiver is also referred to as Rx).
1. ER-RTS->Simultaneous CTS->Simultaneous ER-CTS from Rx
2. ER-RTS->Simultaneous ER-CTS from Rx->Simultaneous CTS
3. ER-RTS->RTS->Simultaneous CTS from Rx->Simultaneous ER-CTS from Rx
4. CTS-to-self->ER-RTS->Simultaneous ER-CTS from Rx->Simultaneous CTS from Rx
5. ER-RTS->Sequential CTS separated by SIFS->Simultaneous ER-CTS from Rx
6. ER-RTS->Simultaneous ER-CTS from Rx->Sequential CTS separated by SIFS
7. ER-RTS->RTS->Sequential CTS separated by SIFS from Rx->Simultaneous ER-CTS from Rx
8. CTS-to-self->ER-RTS->Simultaneous ER-CTS from Rx->Sequential CTS separated by SIFS from Rx
   All the above operations may be repeated with “Simultaneous ER-CTS from Rx” being replaced with “Sequential ER-CTS from Rx.” Sequential CTS or ER-CTS from Rx devices will be in the same order as the user order specified in ER-RTS. The reservation duration from previous operations can be truncated to one transaction and channel reservation is extended subsequently by the following sequence of operations. In some embodiments, the following sequence of operation is after channel reservation using previous operations for the first transaction:
1. The ER-PPDU transmission along with ER-Ack will reserve the channel from ER-supported devices->After ER-Ack Simultaneous CTS is sent to reserve from non-ER supported devices->Next set of transactions.
2. The ER-PPDU transmission along with ER-Ack will reserve the channel from ER-supported devices->After ER-Ack RTS is sent from Tx->Simultaneous CTS from Rx->Next set of transactions.
3. The ER-PPDU transmission along with ER-Ack will reserve the channel from ER-supported devices->After ER-Ack Sequential CTS is sent to reserve from non-ER supported devices->Next set of transactions.
4. The ER-PPDU transmission along with ER-Ack will reserve the channel from ER-supported devices->After ER-Ack RTS is sent from Tx->Sequential CTS from Rx->Next set of transactions.
   In the case of a single Rx, “Simultaneous CTS from Rx” implies the transmission of a single CTS from the receiver. All the above operations may be repeated with ER-Ack being sent sequentially when multiple receivers are involved.

For simultaneous transmission of CTS or ER-CTS, packet content may be the same and the destination may perform pre-compensation for carrier frequency offset and symbol clock error while transmitting the simultaneous CTS or ER-CTS. In some embodiments, the pre-compensation uses the value from the previously received ER-RTS PPDU, and if no ER-RTS PPDU was transmitted from the source then the pre-compensation uses the value from the previously received RTS frame PPDU.

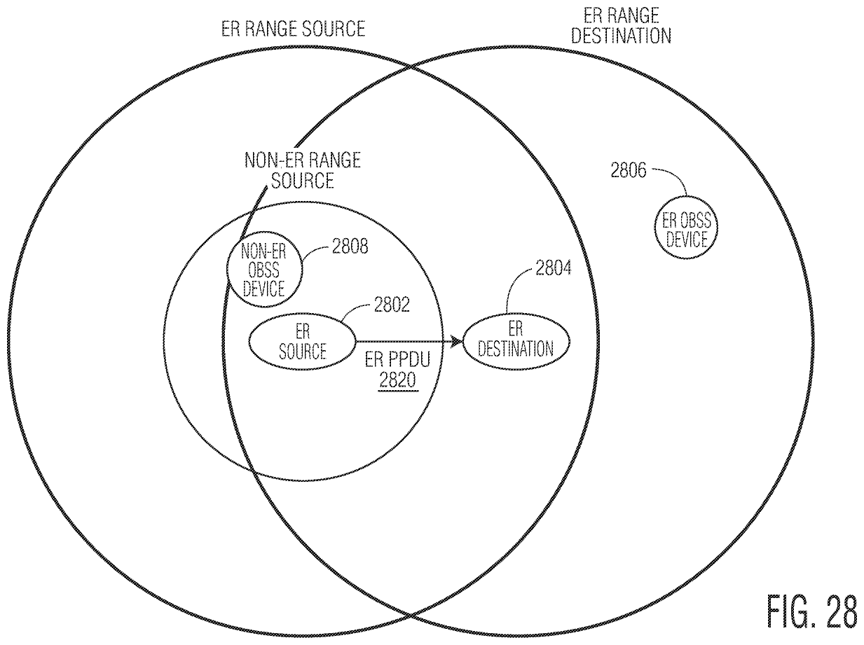

FIG. 28 depicts an ER transmission between an ER source 2802 and an ER destination 2804 in accordance with an embodiment of the invention. In the embodiment depicted in FIG. 28, the ER source 2802 may transmit an extended-range PPDU 2820 to the ER destination 2804. In the embodiment depicted in FIG. 28, one or more non-ER OB SS devices 2808 are located within the non-ER range of the ER source 2802, one or more ER-OBSS devices 2806 and the ER source 2802 are located within the ER range of the ER destination 2804, and the ER destination 2804 is located within the ER range of the ER source 2802. The ER source 2802, the ER destination 2804, the one or more ER OBSS devices 2806, and the one or more non-ER OB SS devices 2808 may be similar to or the same as the ER source 102, the ER destination 104, the one or more ER OBSS devices 106, and the one or more non-ER OB SS devices 108 depicted in FIG. 1, the ER source 302, the ER destination 304, the one or more ER OBSS devices 306, and the one or more non-ER OB SS devices 308 depicted in FIG. 3, the ER source 502, the ER destination 504, the one or more ER OB SS devices 506, and the one or more non-ER OB SS devices 508 depicted in FIG. 5, and the ER source 702, the ER destination 704, the one or more ER OB SS devices 706, and the one or more non-ER OB SS devices 708 depicted in FIG. 7, respectively. The topology between the ER source 2802, the ER destination 2804, the one or more ER OB SS devices 2806, and the one or more non-ER OB SS devices 2808 can be applied for the first channel reservation scheme illustrated in FIG. 1, the second channel reservation scheme illustrated in FIG. 3, the third channel reservation scheme illustrated in FIG. 5, the fourth channel reservation scheme illustrated in FIG. 7, the first mechanism illustrated in FIG. 9, the second mechanism illustrated in FIG. 11, the third mechanism illustrated in FIG. 13, the fourth mechanism illustrated in FIG. 15, the fifth mechanism illustrated in FIG. 17, the sixth mechanism illustrated in FIG. 19, the seventh mechanism illustrated in FIG. 21, and the eighth mechanism illustrated in FIG. 23.

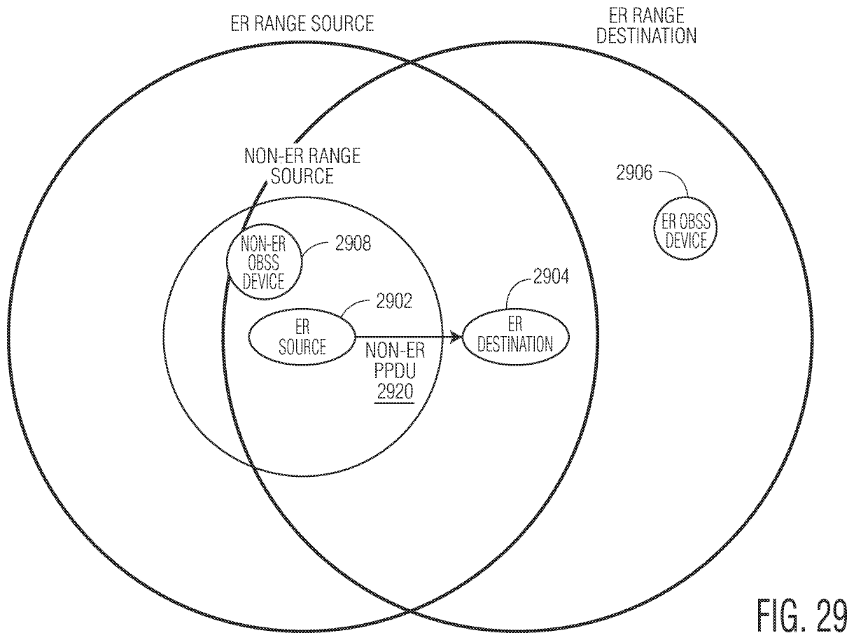

FIG. 29 depicts a non-ER transmission between an ER source 2902 and an ER destination 2904 in accordance with an embodiment of the invention. In the embodiment depicted in FIG. 29, the ER source 2902 may transmit a non-ER PPDU 2920 to the ER destination 2904. In the embodiment depicted in FIG. 29, one or more non-ER OBSS devices 2908 are located within the non-ER range of the ER source 2902, one or more ER OBSS devices 2906 and the ER source 2902 are located within the ER range of the ER destination 2904, and the ER destination 2904 is located within the ER range of the ER source 2902. The ER source 2902, the ER destination 2904, the one or more ER OBSS devices 2906, and the one or more non-ER OB SS devices 2908 may be similar to or the same as the ER source 2502, the ER destination 2504, the one or more ER OB SS devices 2506, and the one or more non-ER OBSS devices 2508 depicted in FIG. 25, respectively. The topology between the ER source 2902, the ER destination 2904, the one or more ER OBSS devices 2906, and the one or more non-ER OB SS devices 2908 can be applied for the fifth channel reservation scheme illustrated in FIG. 25.

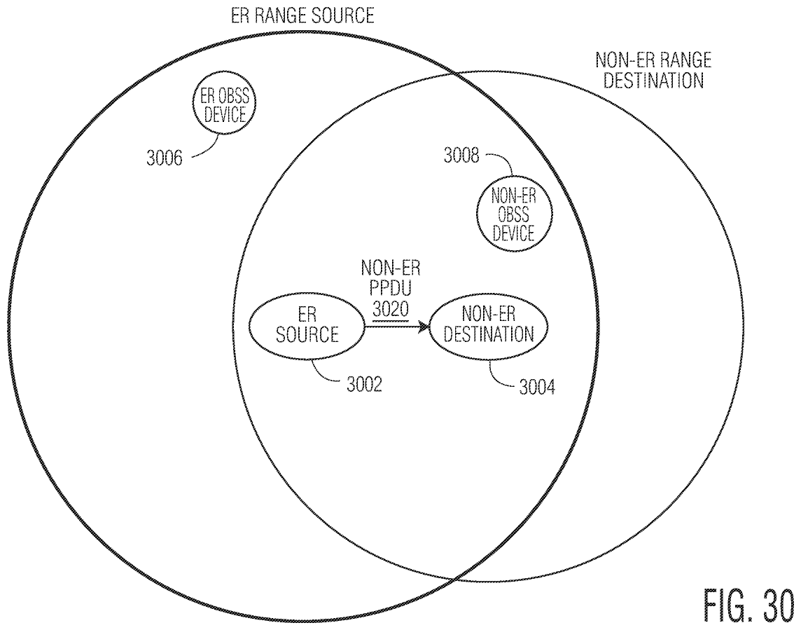

FIG. 30 depicts a non-ER transmission between an ER source 3002 and a non-ER destination 3004 in accordance with an embodiment of the invention. In the embodiment depicted in FIG. 30, the ER source 3002 may transmit a non-ER PPDU 3020 to the non-ER destination 3004. In the embodiment depicted in FIG. 30, one or more ER OB SS devices 3006 and the non-ER destination 3004 are located within the ER range of the ER source 3002, while one or more non-ER OBSS devices 3008 and the ER source 3002 are located within the non-ER range of the non-ER destination 3004. The ER source 3002, the non-ER destination 3004, the one or more ER OB SS devices 3006, and the one or more non-ER OBSS devices 3008 may be similar to or the same as the ER source 2602, the non-ER destination 2604, the one or more ER OBSS devices 2606, and the one or more non-ER OBSS devices 2608 depicted in FIG. 26, respectively. The topology between the ER source 3002, the non-ER destination 3004, the one or more ER OBSS devices 3006, and the one or more non-ER OBSS devices 3008 can be applied for the sixth channel reservation scheme illustrated in FIG. 26.

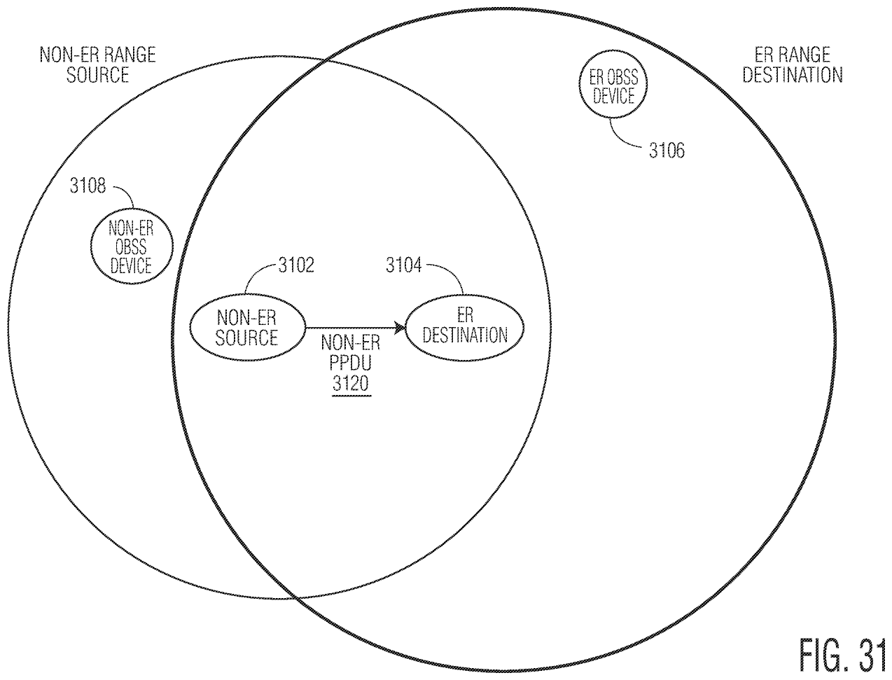

FIG. 31 depicts a non-ER transmission between a non-ER source 3102 and an ER destination 3104 in accordance with an embodiment of the invention. In the embodiment depicted in FIG. 31, the non-ER source 3102 may transmit a non-ER PPDU 3120 to the ER destination 3104. In the embodiment depicted in FIG. 31, one or more non-ER OB SS devices 3108 and the ER destination 3104 are located within the non-ER range of the non-ER source 3102, while one or more ER OBSS devices 3106 and the non-ER source 3102 are located within the ER range of the ER destination 3104. The non-ER source 3102, the ER destination 3104, the one or more ER OBSS devices 3106, and the one or more non-ER OBSS devices 3108 may be similar to or the same as the non-ER source 2702, the ER destination 2704, the one or more ER OB SS devices 2706, and the one or more non-ER OBSS devices 2708 depicted in FIG. 27, respectively. The topology between the non-ER source 3102, the ER destination 3104, the one or more ER OBSS devices 3106, and the one or more non-ER OBSS devices 3108 can be applied for the seventh channel reservation scheme illustrated in FIG. 27.

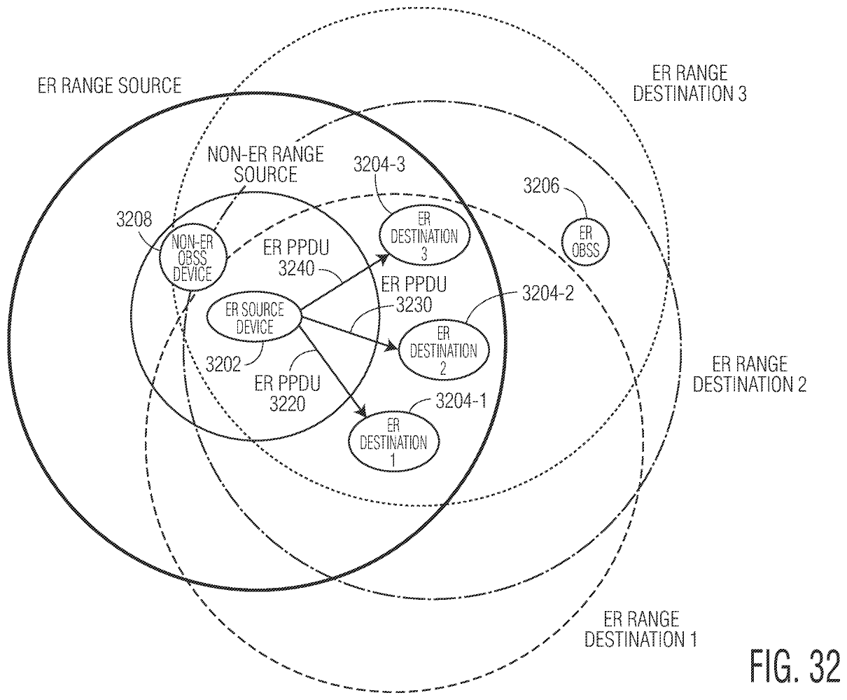

FIG. 32 depicts ER transmissions between an ER source 3202 and multiple ER destinations 3204-1, 3204-2, 3204-3 in accordance with an embodiment of the invention. In the embodiment depicted in FIG. 32, the ER source 3202 may transmit an extended-range PPDU 3220 to the ER destination 3204-1, transmit an extended-range PPDU 3230 to the ER destination 3204-2, and transmit an extended-range PPDU 3240 to the ER destination 3204-3. In the embodiment depicted in FIG. 32, one or more non-ER OB SS devices 3208 are located within the non-ER range of the ER source 3202, one or more ER OBSS devices 3206 and the ER source 3202 are located within the ER range of the ER destination 3204-1 or 3204-3, and the ER destinations 3204-1, 3204-2, 3204-3 are located within the ER range of the ER source 3202. The topology between the ER source 3202, the ER destinations 3204-1, 3204-2, 3204-3, the one or more ER OBSS devices 3206, and the one or more non-ER OBSS devices 3208 can be applied for the first channel reservation scheme illustrated in FIG. 1, the second channel reservation scheme illustrated in FIG. 3, the third channel reservation scheme illustrated in FIG. 5, the fourth channel reservation scheme illustrated in FIG. 7, the first mechanism illustrated in FIG. 9, the second mechanism illustrated in FIG. 11, the third mechanism illustrated in FIG. 13, the fourth mechanism illustrated in FIG. 15, the fifth mechanism illustrated in FIG. 17, the sixth mechanism illustrated in FIG. 19, the seventh mechanism illustrated in FIG. 21, and the eighth mechanism illustrated in FIG. 23.

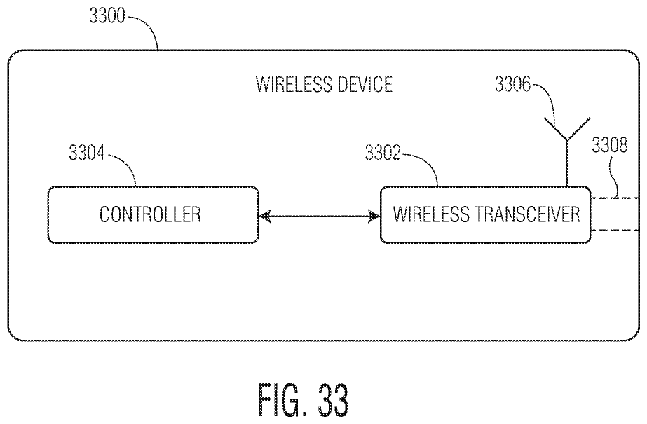

FIG. 33 depicts a wireless device 3300 in accordance with an embodiment of the invention. The wireless device 3300 may be an embodiment of the ER source 102, the ER destination 104, the one or more ER OB SS devices 106, and the one or more non-ER OB SS devices 108 depicted in FIG. 1, the ER source 302, the ER destination 304, the one or more ER OBSS devices 306, and the one or more non-ER OBSS devices 308 depicted in FIG. 3, the ER source 502, the ER destination 504, the one or more ER OBSS devices 506, and the one or more non-ER OBSS devices 508 depicted in FIG. 5, the ER source 702, the ER destination 704, the one or more ER OBSS devices 706, and the one or more non-ER OBSS devices 708 depicted in FIG. 7, the ER source 2502, the ER destination 2504, the one or more ER OBSS devices 2506, and the one or more non-ER OBSS devices 2508 depicted in FIG. 25, the ER source 2602, the non-ER destination 2504, the one or more ER OBSS devices 2606, and the one or more non-ER OBSS devices 2608 depicted in FIG. 26, the non-ER source 2702, the ER destination 2704, the one or more ER OBSS devices 2706, and the one or more non-ER OBSS devices 2708 depicted in FIG. 27, the ER source 2802, the ER destination 2804, the one or more ER OBSS devices 2806, and the one or more non-ER OBSS devices 2808 depicted in FIG. 28, the ER source 2902, the ER destination 2904, the one or more ER OBSS devices 2906, and the one or more non-ER OBSS devices 2908 depicted in FIG. 29, the ER source 3002, the non-ER destination 3004, the one or more ER OBSS devices 3006, and the one or more non-ER OBSS devices 3008 depicted in FIG. 30, the non-ER source 3102, the ER destination 3104, the one or more ER OBSS devices 3106, and the one or more non-ER OBSS devices 3108 depicted in FIG. 31, and/or the ER source 3202, the ER destinations 3204-1, 3204-2, 3204-3, the one or more ER OBSS devices 3206, and the one or more non-ER OBSS devices 3208 depicted in FIG. 32. However, the ER source 102, the ER destination 104, the one or more ER OBSS devices 106, and the one or more non-ER OBSS devices 108 depicted in FIG. 1, the ER source 302, the ER destination 304, the one or more ER OBSS devices 306, and the one or more non-ER OBSS devices 308 depicted in FIG. 3, the ER source 502, the ER destination 504, the one or more ER OBSS devices 506, and the one or more non-ER OBSS devices 508 depicted in FIG. 5, the ER source 702, the ER destination 704, the one or more ER OBSS devices 706, and the one or more non-ER OBSS devices 708 depicted in FIG. 7, the ER source 2502, the ER destination 2504, the one or more ER OBSS devices 2506, and the one or more non-ER OBSS devices 2508 depicted in FIG. 25, the ER source 2602, the non-ER destination 2504, the one or more ER OBSS devices 2606, and the one or more non-ER OBSS devices 2608 depicted in FIG. 26, the non-ER source 2702, the ER destination 2704, the one or more ER OB SS devices 2706, and the one or more non-ER OBSS devices 2708 depicted in FIG. 27, the ER source 2802, the ER destination 2804, the one or more ER OB SS devices 2806, and the one or more non-ER OBSS devices 2808 depicted in FIG. 28, the ER source 2902, the ER destination 2904, the one or more ER OB SS devices 2906, and the one or more non-ER OBSS devices 2908 depicted in FIG. 29, the ER source 3002, the non-ER destination 3004, the one or more ER OB SS devices 3006, and the one or more non-ER OBSS devices 3008 depicted in FIG. 30, the non-ER source 3102, the ER destination 3104, the one or more ER OB SS devices 3106, and the one or more non-ER OBSS devices 3108 depicted in FIG. 31, and/or the ER source 3202, the ER destinations 3204-1, 3204-2, 3204-3, the one or more ER OB SS devices 3206, and the one or more non-ER OB SS devices 3208 depicted in FIG. 32 are not limited to the embodiment depicted in FIG. 33. In the embodiment depicted in FIG. 33, the wireless device 3300 includes a wireless transceiver 3302, a controller 3304 operably connected to the wireless transceiver, and at least one antenna 3306 operably connected to the wireless transceiver. In some embodiments, the wireless device 3300 may include at least one optional network port 3308 operably connected to the wireless transceiver. In some embodiments, the wireless transceiver includes a physical layer (PHY) device. The wireless transceiver may be any suitable type of wireless transceiver. For example, the wireless transceiver may be a wireless local area network (WLAN) transceiver (e.g., a transceiver compatible with an IEEE 802.11 protocol). In some embodiments, the wireless device 3300 includes multiple transceivers. The controller may be configured to control the wireless transceiver to process packets received through the antenna and/or the network port and/or to generate outgoing packets to be transmitted through the antenna and/or the network port. In some embodiments, the controller is implemented within a processor, such as a microcontroller, a host processor, a host, a digital signal processor (DSP), or a central processing unit (CPU). The antenna may be any suitable type of antenna. For example, the antenna may be an induction type antenna such as a loop antenna or any other suitable type of induction type antenna. However, the antenna is not limited to an induction type antenna. The network port may be any suitable type of port. The wireless device 3300 may be compatible with an IEEE 802.11 protocol.

In accordance with an embodiment of the invention, the controller 3304 is configured to generate an extended range request-to-send (ER-RTS) packet, and the wireless transceiver 3302 is configured to transmit the ER-RTS packet to a second wireless device to reserve a transmission channel. In some embodiments, the transmission channel includes a wireless transmission channel between the wireless device 3300 and the second wireless device. In some embodiments, the wireless transceiver is further configured to transmit data through the transmission channel after receiving an extended range clear-to-send (ER-CTS) packet from the second wireless device. In some embodiments, two CTS packets are transmitted by the wireless device and the second wireless device before the ER-CTS packet is received by the wireless transceiver from the second wireless device. In some embodiments, two CTS packets are simultaneously transmitted by the wireless device and the second wireless device before the ER-CTS packet is received by the wireless transceiver from the second wireless device. In some embodiments, an RTS packet is transmitted by the wireless device to the second wireless device and a CTS packet is transmitted by the second wireless device to the wireless device before the ER-CTS packet is received by the wireless transceiver from the second wireless device. In some embodiments, the wireless transceiver is further configured to transmit data through the transmission channel after two CTS packets are transmitted by the wireless device and the second wireless device. In some embodiments, the wireless transceiver is further configured to transmit data through the transmission channel after two CTS packets are simultaneously transmitted by the wireless device and the second wireless device. In some embodiments, the wireless transceiver is further configured to receive an ER-CTS packet from the second wireless device before two CTS packets are transmitted by the wireless device and the second wireless device. In some embodiments, the wireless transceiver is further configured to transmit data through the transmission channel after receiving a clear-to-send (CTS) packet from the second wireless device. In some embodiments, the wireless transceiver is further configured to receive an ER-CTS packet from the second wireless device before the CTS packet is received by the wireless transceiver from the second wireless device. In some embodiments, the wireless device is compatible with an Institute of Electrical and Electronics Engineers (IEEE) 802.11 protocol. In some embodiments, an RTS packet is transmitted by the wireless device to the second wireless device and a CTS packet is transmitted by the second wireless device to the wireless device.

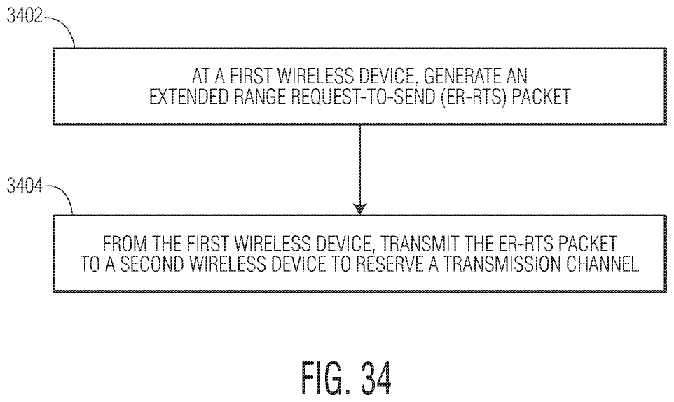

FIG. 34 is a process flow diagram of a method for wireless communications in accordance with an embodiment of the invention. At block 3402, at a first wireless device, an extended range request-to-send (ER-RTS) packet is generated. At block 3404, from the first wireless device, the ER-RTS packet is transmitted to a second wireless device to reserve a transmission channel. In some embodiments, the transmission channel includes a wireless transmission channel between the first wireless device and the second wireless device. In some embodiments, data is transmitted from the first wireless device through the transmission channel after receiving an extended range clear-to-send (ER-CTS) packet from the second wireless device. In some embodiments, two CTS packets are transmitted by the first wireless device and the second wireless device before the ER-CTS packet is received at the first wireless device from the second wireless device. In some embodiments, two CTS packets are simultaneously transmitted by the first wireless device and the second wireless device before the ER-CTS packet is received at the first wireless device from the second wireless device. In some embodiments, an RTS packet is transmitted by the first wireless device to the second wireless device and a CTS packet is transmitted by the second wireless device to the first wireless device before the ER-CTS packet is received by the first wireless device from the second wireless device. In some embodiments, data is transmitted through the transmission channel after two CTS packets are transmitted by the first wireless device and the second wireless device. In some embodiments, data is transmitted through the transmission channel after two CTS packets are simultaneously transmitted by the first wireless device and the second wireless device. In some embodiments, an extended range clear-to-send (ER-CTS) packet is received from the second wireless device before two CTS packets are transmitted by the first wireless device and the second wireless device. In some embodiments, data is transmitted through the transmission channel after receiving a clear-to-send (CTS) packet from the second wireless device. In some embodiments, an extended range clear-to-send (ER-CTS) packet is received from the second wireless device before the CTS packet is received by the first wireless device from the second wireless device. In some embodiments, the first wireless device is compatible with an Institute of Electrical and Electronics Engineers (IEEE) 802.11 protocol. The first wireless device and/or the second wireless device may be the same as or similar to the ER source 102 and/or the ER destination 104 depicted in FIG. 1, the ER source 302 and/or the ER destination 304 depicted in FIG. 3, the ER source 502 and/or the ER destination 504 depicted in FIG. 5, the ER source 702 and/or the ER destination 704 depicted in FIG. 7, the ER source 2502 and/or the ER destination 2504 depicted in FIG. 25, the ER source 2802 and/or the ER destination 2804 depicted in FIG. 28, the ER source 2902 and/or the ER destination 2904 depicted in FIG. 29, and/or the ER source 3202 and/or the ER destinations 3204-1, 3204-2, 3204-3 depicted in FIG. 32.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A wireless device comprising:
a controller configured to generate an extended range request-to-send (ER-RTS) packet; and
a wireless transceiver configured to transmit the ER-RTS packet to a second wireless device to reserve a transmission channel.

2. The wireless device of claim 1, wherein the transmission channel comprises a wireless transmission channel between the wireless device and the second wireless device.

3. The wireless device of claim 2, wherein the wireless transceiver is further configured to transmit data through the transmission channel after receiving an extended range clear-to-send (ER-CTS) packet from the second wireless device.

4. The wireless device of claim 3, wherein two CTS packets are transmitted by the wireless device and the second wireless device before the ER-CTS packet is received by the wireless transceiver from the second wireless device.

5. The wireless device of claim 3, wherein two CTS packets are simultaneously transmitted by the wireless device and the second wireless device before the ER-CTS packet is received by the wireless transceiver from the second wireless device.

6. The wireless device of claim 3, wherein an RTS packet is transmitted by the wireless device to the second wireless device and a CTS packet is transmitted by the second wireless device to the wireless device before the ER-CTS packet is received by the wireless transceiver from the second wireless device.

7. The wireless device of claim 2, wherein the wireless transceiver is further configured to transmit data through the transmission channel after two CTS packets are transmitted by the wireless device and the second wireless device.

8. The wireless device of claim 2, wherein the wireless transceiver is further configured to transmit data through the transmission channel after two CTS packets are simultaneously transmitted by the wireless device and the second wireless device.

9. The wireless device of claim 7, wherein the wireless transceiver is further configured to receive an extended range clear-to-send (ER-CTS) packet from the second wireless device before two CTS packets are transmitted by the wireless device and the second wireless device.

10. The wireless device of claim 2, wherein the wireless transceiver is further configured to transmit data through the transmission channel after receiving a clear-to-send (CTS) packet from the second wireless device.

11. The wireless device of claim 10, wherein the wireless transceiver is further configured to receive an extended range clear-to-send (ER-CTS) packet from the second wireless device before the CTS packet is received by the wireless transceiver from the second wireless device.

12. The wireless device of claim 1, wherein the wireless device is compatible with an Institute of Electrical and Electronics Engineers (IEEE) 802.11 protocol.

13. The wireless device of claim 1, wherein an RTS packet is transmitted by the wireless device to the second wireless device and a clear-to-send (CTS) packet is transmitted by the second wireless device to the wireless device.

14. An extended range (ER) source compatible with an Institute of Electrical and Electronics Engineers (IEEE) 802.11 protocol, the ER source comprising:
a controller configured to generate an extended range request-to-send (ER-RTS) packet or an RTS packet; and
a wireless transceiver configured to transmit the ER-RTS packet or the RTS packet to an ER destination to reserve a wireless transmission channel between the ER source and the ER destination and to transmit data through the wireless transmission channel after receiving an extended range clear-to-send (ER-CTS) packet from the ER destination.

15. The ER source of claim 14, wherein two CTS packets are transmitted by the ER source and the ER destination before the ER-CTS packet is received by the wireless transceiver from the ER destination.

16. The ER source of claim 14, wherein two CTS packets are simultaneously transmitted by the ER source and the ER destination before the ER-CTS packet is received by the wireless transceiver from the ER destination.

17. The ER source of claim 14, wherein an RTS packet is transmitted by the ER source to the ER destination and a CTS packet is transmitted by the ER destination to the ER source before the ER-CTS packet is received by the wireless transceiver from the ER destination.

18. The ER source of claim 14, wherein the wireless transceiver is further configured to receive the ER-CTS packet from the ER destination before two CTS packets are transmitted by the ER source and the ER destination.

19. The ER source of claim 14, wherein the wireless transceiver is further configured to receive the ER-CTS packet from the ER destination before a CTS packet is received by the wireless transceiver from the ER destination.

20. A method for wireless communications, the method comprising:
at a first wireless device, generating an extended range request-to-send (ER-RTS) packet; and
from the first wireless device, transmitting the ER-RTS packet to a second wireless device to reserve a transmission channel.
